(19) United States
(12) Patent Application Publication
(10) Pub. No.: US 2026/0133631 A1
(43) Pub. Date: May 14, 2026

(54) WEARABLE DEVICE, METHOD, AND NON-TRANSITORY COMPUTER-READABLE STORAGE MEDIUM FOR INTERACTION WITH USER'S GAZE

(71) Applicant: SAMSUNG ELECTRONICS CO., LTD., Suwon-si (KR)

(72) Inventors: Dongil SON, Suwon-si (KR); Kwangtai KIM, Suwon-si (KR); Seungnyun KIM, Suwon-si (KR)

(73) Assignee: SAMSUNG ELECTRONICS CO., LTD., Suwon-si (KR)

(21) Appl. No.: 19/444,936

(22) Filed: Jan. 9, 2026

Related U.S. Application Data
(63) Continuation of application No. PCT/KR2024/007032, filed on May 23, 2024.

(30) Foreign Application Priority Data
Jul. 21, 2023 (KR) 10-2023-0095598
Aug. 9, 2023 (KR) 10-2023-0104467

(51) Int. Cl. G06F 3/01; G06F 3/16; G06V 20/20; G10L 15/18; G10L 15/22

(52) U.S. Cl. CPC G06F 3/013; G06F 3/167; G06V 20/20; G10L 15/1815; G10L 15/22; G10L 2015/223

(57) ABSTRACT

A method executed by a wearable device, includes: obtaining a voice input of the user, executing a function indicated by the voice input of the user, based on an artificial intelligence (AI) voice recognition model, identifying the gaze of the user, based on data for outputting an execution result of the function indicated by the voice input being generated, identifying whether the gaze is located within a first reference distance from a visual object associated with the AI voice recognition model, based on identifying that the gaze is located within the first reference distance from the visual object and based on the data for outputting the execution result, outputting the execution result, and based on identifying that the gaze is located outside the first reference distance from the visual object, postponing outputting the execution result.

### CROSS-REFERENCE TO RELATED APPLICATIONS

This application is a by-pass continuation application of International Application No. PCT/KR 2024/007032, filed on May 23, 2024, which is based on and claims priority to Korean Patent Application No. 10-2023-0095598, filed on Jul. 21, 2023, Korean Patent Application No. 10-2023-0104467, filed on Aug. 9, 2023, in the Korean Intellectual Property Office, the disclosures of which are incorporated by reference herein their entireties.

### BACKGROUND

### 1. Field

The present disclosure relates to a wearable device, a method, and a non-transitory computer readable storage medium for interaction with a gaze of a user.

### 2. Description of Related Art

In order to provide an enhanced user experience, an electronic device that provides an augmented reality (AR) service for displaying computer-generated information in association with an external object in the real-world is being developed. The electronic device may be a wearable device that may be worn by a user. For example, the electronic device may be AR glasses and/or a head-mounted device (HMD).

### SUMMARY

According to an aspect of the disclosure, A wearable device includes: at least one sensor configured to data for identifying a gaze of a user wearing the wearable device; a display configured to display a stereoscopic image; at least one microphone; at least one processor; and memory storing instructions, wherein the instructions are configured, when executed by the at least one processor, to cause the wearable device to: obtain a voice input of the user via the at least one microphone, execute a function indicated by the voice input of the user, based on an artificial intelligence (AI) voice recognition model, identify the gaze of the user, based on the data obtained via the at least one sensor, based on data for outputting an execution result of the function indicated by the voice input being generated, identify whether the gaze is located within a first reference distance from a visual object associated with the AI voice recognition model displayed on the display, based on identifying that the gaze is located within the first reference distance from the visual object and based on the data for outputting the execution result, output the execution result, and based on identifying that the gaze is located outside the first reference distance from the visual object, postpone outputting the execution result.

According to an aspect of the disclosure, a method executed by a wearable device including at least one sensor configured to obtain data for identifying a gaze of a user wearing the wearable device, a display configured to display a stereoscopic image, and at least one microphone, includes: obtaining a voice input of the user, via the at least one microphone, executing a function indicated by the voice input of the user, based on an artificial intelligence (AI) voice recognition model, identifying the gaze of the user, based on the data obtained via the at least one sensor, based on data for outputting an execution result of the function indicated by the voice input being generated, identifying whether the gaze is located within a first reference distance from a visual object associated with the AI voice recognition model displayed on the display, based on identifying that the gaze is located within the first reference distance from the visual object and based on the data for outputting the execution result, outputting the execution result, and based on identifying that the gaze is located outside the first reference distance from the visual object, postponing outputting the execution result.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to various embodiments;

FIG. 2A illustrates an example of a perspective view of a wearable device according to an embodiment;

FIG. 2B illustrates an example of one or more hardware disposed in a wearable device according to an embodiment;

FIG. 3A illustrates an example of an exterior of a wearable device according to an embodiment;

FIG. 3B illustrates an example of an exterior of a wearable device according to an embodiment;

FIG. 4 illustrates an example of a block diagram of a wearable device according to an embodiment;

FIG. 5A illustrates an example of a field-of-view (FOV) of a user wearing a wearable device in an embodiment;

FIG. 5B illustrates an example of a situation in which input of a user wearing a wearable device is obtained in an embodiment;

FIG. 6A illustrates an example of a screen displayed by a wearable device in an embodiment;

FIG. 6B illustrates an example of a screen displayed by a wearable device in an embodiment;

FIG. 6C illustrates an example of a screen displayed by a wearable device in an embodiment;

FIG. 6D illustrates an example of a screen displayed by a wearable device in an embodiment;

FIG. 6E illustrates an example of a screen displayed by a wearable device in an embodiment;

FIG. 7 illustrates an example of a screen displayed by a wearable device in an embodiment;

FIG. 8 illustrates an example of a screen displayed by a wearable device in an embodiment;

FIG. 9 illustrates a flowchart of operations performed by a wearable device in an embodiment;

FIG. 10 illustrates a flowchart of operations performed by a wearable device in an embodiment;

FIG. 11 illustrates a flowchart of operations performed by a wearable device in an embodiment;

FIG. 12 illustrates a flowchart of operations performed by a wearable device in an embodiment;

### DETAILED DESCRIPTION

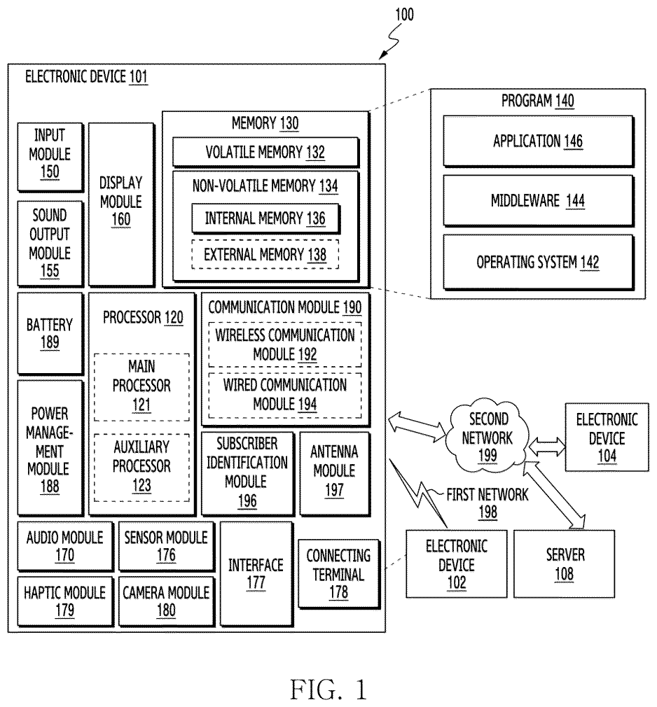

FIG. 1 is a block diagram of an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module(SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited to the above examples. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., through a wire or wires) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., through a wire or wires) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. Throughout the present disclosure, “in response to” may be replaced or interchangeable with “based on”.

The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra-low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

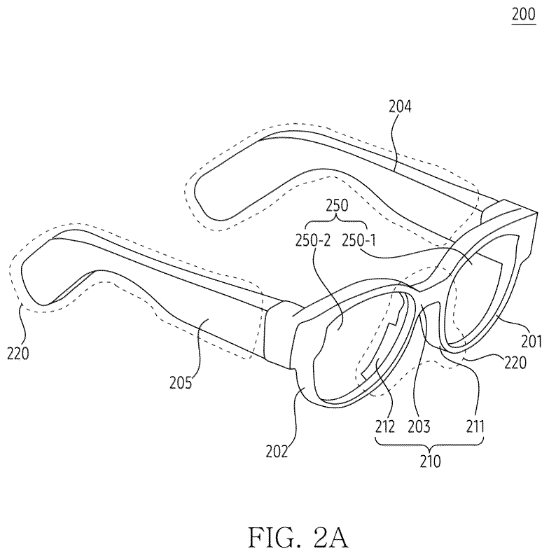

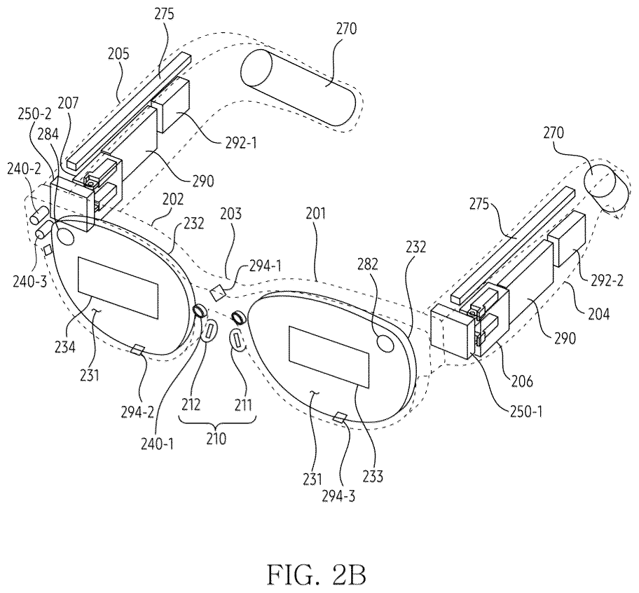

FIG. 2A illustrates an example of a perspective view of a wearable device 200 according to an embodiment. FIG. 2B illustrates an example of one or more hardware disposed in a wearable device 200 according to an embodiment. The wearable device 200 of FIGS. 2A to 2B may correspond to the electronic device 101 of FIG. 1. As shown in FIG. 2A, according to an embodiment, the wearable device 200 may include at least one display 250 and a frame supporting the at least one display 250.

According to an embodiment, the wearable device 200 may be wearable on a portion of the user's body. The wearable device 200 may provide augmented reality (AR), virtual reality (VR), or mixed reality (MR) combining the augmented reality and the virtual reality to a user wearing the wearable device 200. For example, the wearable device 200 may output a virtual reality image through at least one display 250, in response to a user's preset gesture obtained through a motion recognition camera 240-2 of FIG. 2B.

According to an embodiment, the at least one display 250 in the wearable device 200 may provide visual information to a user. For example, the at least one display 250 may include a transparent or translucent lens. The at least one display 250 may include a first display 250-1 and/or a second display 250-2 spaced apart from the first display 250-1. For example, the first display 250-1 and the second display 250-2 may be disposed at positions corresponding to the user's left and right eyes, respectively.

Referring to FIG. 2B, the at least one display 250 may form a display area on the lens to provide a user wearing the wearable device 200 with visual information included in ambient light passing through the lens and other visual information distinct from the visual information. The lens may be formed based on at least one of a fresnel lens, a pancake lens, or a multi-channel lens. The display area formed by the at least one display 250 may be formed on the second surface 232 of the first surface 231 and the second surface 232 of the lens. When the user wears the wearable device 200, ambient light may be transmitted to the user by being incident on the first surface 231 and being penetrated through the second surface 232. For another example, the at least one display 250 may display a virtual reality image to be coupled with a reality screen transmitted through ambient light. The virtual reality image outputted from the at least one display 250 may be transmitted to eyes of the user, through one or more hardware (e.g., optical devices 282 and 284, and/or at least one waveguides 233 and 234) included in the wearable device 200.

According to an embodiment, the wearable device 200 may include waveguides 233 and 234 that transmit light transmitted from the at least one display 250 and relayed by the at least one optical device 282 and 284 by diffracting to the user. The waveguides 233 and 234 may be formed based on at least one of glass, plastic, or polymer. A nano pattern may be formed on at least a portion of the outside or inside of the waveguides 233 and 234. The nano pattern may be formed based on a grating structure having a polygonal or curved shape. Light incident to an end of the waveguides 233 and 234 may be propagated to another end of the waveguides 233 and 234 by the nano pattern. The waveguides 233 and 234 may include at least one of at least one diffraction element (e.g., a diffractive optical element (DOE), a holographic optical element (HOE)), and a reflection element (e.g., a reflection mirror). For example, the waveguides 233 and 234 may be disposed in the wearable device 200 to guide a screen displayed by the at least one display 250 to the user's eyes. For example, the screen may be transmitted to the user's eyes through total internal reflection (TIR) generated in the waveguides 233 and 234.

According to an embodiment, the wearable device 200 may analyze an object included in a real image collected through a photographing camera 240-1, combine with a virtual object corresponding to an object that become a subject of augmented reality provision among the analyzed object, and display on the at least one display 250. The virtual object may include at least one of text and images for various information associated with the object included in the real image. The wearable device 200 may analyze the object based on a multi-camera such as a stereo camera. For the object analysis, the wearable device 200 may execute time-of-flight (ToF) and/or simultaneous localization and mapping (SLAM) supported by the multi-camera. The user wearing the wearable device 200 may watch an image displayed on the at least one display 250.

According to an embodiment, a frame may be configured with a physical structure in which the wearable device 200 may be worn on the user's body. According to an embodiment, the frame may be configured so that when the user wears the wearable device 200, the first display 250-1 and the second display 250-2 may be positioned corresponding to the user's left and right eyes. The frame may support the at least one display 250. For example, the frame may support the first display 250-1 and the second display 250-2 to be positioned at positions corresponding to the user's left and right eyes.

Referring to FIG. 2A, according to an embodiment, the frame may include an area 220 at least partially in contact with the portion of the user's body in case that the user wears the wearable device 200. For example, the area 220 of the frame in contact with the portion of the user's body may include an area in contact with a portion of the user's nose, a portion of the user's ear, and a portion of the side of the user's face that the wearable device 200 contacts. According to an embodiment, the frame may include a nose pad 210 that is contacted on the portion of the user's body. When the wearable device 200 is worn by the user, the nose pad 210 may be contacted on the portion of the user's nose. The frame may include a first temple 204 and a second temple 205, which are contacted on another portion of the user's body that is distinct from the portion of the user's body.

According to an embodiment, the frame may include a first rim 201 surrounding at least a portion of the first display 250-1, a second rim 202 surrounding at least a portion of the second display 250-2, a bridge 203 disposed between the first rim 201 and the second rim 202, a first pad 211 disposed along a portion of the edge of the first rim 201 from one end of the bridge 203, a second pad 212 disposed along a portion of the edge of the second rim 202 from the other end of the bridge 203, the first temple 204 extending from the first rim 201 and fixed to a portion of the wearer's ear, and the second temple 205 extending from the second rim 202 and fixed to a portion of the ear opposite to the ear. The first pad 211 and the second pad 212 may be in contact with the portion of the user's nose, and the first temple 204 and the second temple 205 may be in contact with a portion of the user's face and the portion of the user's ear. The temples 204 and 205 may be rotatably connected to the rim through hinge units 206 and 207 of FIG. 2B. The first temple 204 may be rotatably connected with respect to the first rim 201 through the first hinge unit 206 disposed between the first rim 201 and the first temple 204. The second temple 205 may be rotatably connected with respect to the second rim 202 through the second hinge unit 207 disposed between the second rim 202 and the second temple 205. According to an embodiment, the wearable device 200 may identify an external object (e.g., a user's fingertip) touching the frame and/or a gesture performed by the external object by using a touch sensor, a grip sensor, and/or a proximity sensor formed on at least a portion of the surface of the frame.

According to an embodiment, the wearable device 200 may include hardware (e.g., hardware described above based on the block diagram of FIG. 1) that performs various functions. For example, the hardware may include a battery module 270, an antenna module 275, optical devices 282 and 284, speakers 292-1 and 292-2, microphones 294-1, 294-2, and 294-3, a light emitting module (not illustrated), and/or a printed circuit board (PCB) 290. Various hardware may be disposed in the frame.

According to an embodiment, the microphones 294-1, 294-2, and 294-3 of the wearable device 200 may obtain a sound signal, by being disposed on at least a portion of the frame. The first microphone 294-1 disposed on the nose pad 210, the second microphone 294-2 disposed on the second rim 202, and the third microphone 294-3 disposed on the first rim 201 are illustrated in FIG. 2B, but the number and disposition of the microphone 294 are not limited to an embodiment of FIG. 2B. In a case that the number of the microphone 294 included in the wearable device 200 is two or more, the wearable device 200 may identify a direction of the sound signal by using a plurality of microphones disposed on different portions of the frame.

According to an embodiment, the optical devices 282 and 284 may transmit a virtual object transmitted from the at least one display 250 to the waveguides 233 and 234. For example, the optical devices 282 and 284 may be projectors. The optical devices 282 and 284 may be disposed adjacent to the at least one display 250 or may be included in the at least one display 250 as a portion of the at least one display 250. The first optical device 282 may correspond to the first display 250-1, and the second optical device 284 may correspond to the second display 250-2. The first optical device 282 may transmit light outputted from the first display 250-1 to the first waveguide 233, and the second optical device 284 may transmit light outputted from the second display 250-2 to the second waveguide 234.

In an embodiment, a camera 240 may include an eye tracking camera (ET CAM) 240-1, a motion recognition camera 240-2 and/or the photographing camera 240-3. The photographing camera, the eye tracking camera 240-1, and the motion recognition camera 240-2 may be disposed at different positions on the frame and may perform different functions. The eye tracking camera 240-1 may output data indicating a gaze of the user wearing the wearable device 200. For example, the wearable device 200 may detect the gaze from an image including the user's pupil, obtained through the eye tracking camera 240-1. An example in which the eye tracking camera 240-1 is disposed toward the user's right eye is illustrated in FIG. 2B, but the embodiment is not limited to the above example, and the eye tracking camera 240-1 may be disposed alone toward the user's left eye or may be disposed toward two eyes.

In an embodiment, the photographing camera 240-3 may photograph a real image or background to be matched with a virtual image in order to implement the augmented reality or mixed reality content. The photographing camera may photograph an image of a specific object existing at a position viewed by the user and may provide the image to the at least one display 250. The at least one display 250 may display one image in which a virtual image provided through the optical devices 282 and 284 is overlapped with information on the real image or background including the image of the specific object obtained by using the photographing camera. In an embodiment, the photographing camera may be disposed on the bridge 203 disposed between the first rim 201 and the second rim 202.

In an embodiment, the eye tracking camera 240-1 may implement a more realistic augmented reality by matching the user's gaze with the visual information provided on the at least one display 250, by tracking the gaze of the user wearing the wearable device 200. For example, when the user looks at the front, the wearable device 200 may naturally display environment information associated with the user's front on the at least one display 250 at a position where the user is positioned. The eye tracking camera 240-1 may be configured to capture an image of the user's pupil in order to determine the user's gaze. For example, the eye tracking camera 240-1 may receive gaze detection light reflected from the user's pupil and may track the user's gaze based on the position and movement of the received gaze detection light. In an embodiment, the eye tracking camera 240-1 may be disposed at a position corresponding to the user's left and right eyes. For example, the eye tracking camera 240-1 may be disposed in the first rim 201 and/or the second rim 202 to face the direction in which the user wearing the wearable device 200 is positioned.

The motion recognition camera 240-2 may provide a specific event to the screen provided on the at least one display 250 by recognizing the movement of the whole or portion of the user's body, such as the user's torso, hand, or face. The motion recognition camera 240-2 may obtain a signal corresponding to motion by recognizing the user's gesture, and may provide a display corresponding to the signal to the at least one display 250. A processor may identify a signal corresponding to the operation and may perform a preset function based on the identification. In an embodiment, the motion recognition camera 240-2 may be disposed on the first rim 201 and/or the second rim 202.

In an embodiment, the camera 240 included in the wearable device 200 is not limited to the above-described eye tracking camera 240-1 and the motion recognition camera 240-2. For example, the wearable device 200 may identify an external object included in the FoV by using the photographing camera 240-3 disposed toward the user's FoV. Identifying of the external object by the wearable device 200 may be performed through a sensor for identifying a distance between the wearable device 200 and the external object, such as a depth sensor and/or a time of flight (ToF) sensor. The camera 240 disposed toward the FoV may support an autofocus function and/or an optical image stabilization (OIS) function. For example, the wearable device 200 may include a camera 240 (e.g., a face tracking (FT) camera) disposed toward a face of a user wearing the wearable device 200 to obtain an image including the user's face.

Although not illustrated, the wearable device 200 according to an embodiment may further include a light source (e.g., LED) that emits light toward a subject (e.g., user's eyes, face, and/or an external object in the FoV) photographed by using the camera 240. The light source may include an LED having an infrared wavelength. The light source may be disposed on at least one of the frame, and the hinge units 206 and 207.

According to an embodiment, the battery module 270 may supply power to electronic components of the wearable device 200. In an embodiment, the battery module 270 may be disposed in the first temple 204 and/or the second temple 205. For example, the battery module 270 may be a plurality of battery modules 270. The plurality of battery modules 270, respectively, may be disposed on each of the first temple 204 and the second temple 205. In an embodiment, the battery module 270 may be disposed at an end of the first temple 204 and/or the second temple 205.

According to an embodiment, the antenna module 275 may transmit the signal or power to the outside of the wearable device 200 or may receive the signal or power from the outside. The antenna module 275 may be electrically and/or operably connected to the at least one display 250 of FIG. 2A or FIG. 2B. In an embodiment, the antenna module 275 may be disposed in the first temple 204 and/or the second temple 205. For example, the antenna module 275 may be disposed close to one surface of the first temple 204 and/or the second temple 205.

According to an embodiment, the speakers 292-1 and 292-2 may output a sound signal to the outside of the wearable device 200. A sound output module may be referred to as a speaker. In an embodiment, the speakers 292-1 and 292-2 may be disposed in the first temple 204 and/or the second temple 205 in order to be disposed adjacent to the ear of the user wearing the wearable device 200. For example, the wearable device 200 may include a second speaker 292-2 disposed adjacent to the user's left ear by being disposed in the first temple 204, and a first speaker 292-1 disposed adjacent to the user's right ear by being disposed in the second temple 205.

In an embodiment, the light emitting module (not illustrated) may include at least one light emitting element. The light emitting module may emit light of a color corresponding to a specific state or may emit light through an operation corresponding to the specific state in order to visually provide information on a specific state of the wearable device 200 to the user. For example, when the wearable device 200 requires charging, it may repeatedly emit red light at a designated timing. In an embodiment, the light emitting module may be disposed on the first rim 201 and/or the second rim 202.

Referring to FIG. 2B, according to an embodiment, the wearable device 200 may include the printed circuit board (PCB) 290. The PCB 290 may be included in at least one of the first temple 204 or the second temple 205. The PCB 290 may include an interposer disposed between at least two sub PCBs. On the PCB 290, one or more hardware included in the wearable device 200 may be disposed. The wearable device 200 may include a flexible PCB (FPCB) for interconnecting the hardware.

According to an embodiment, the wearable device 200 may include at least one of a gyro sensor, a gravity sensor, and/or an acceleration sensor for detecting the posture of the wearable device 200 and/or the posture of a body part (e.g., a head) of the user wearing the wearable device 200. Each of the gravity sensor and the acceleration sensor may measure gravity acceleration, and/or acceleration based on preset 3-dimensional axes (e.g., x-axis, y-axis, and z-axis) perpendicular to each other. The gyro sensor may measure angular velocity of each of preset 3-dimensional axes (e.g., x-axis, y-axis, and z-axis). At least one of the gravity sensor, the acceleration sensor, and the gyro sensor may be referred to as an inertial measurement unit (IMU). According to an embodiment, the wearable device 200 may identify the user's motion and/or gesture performed to execute or stop a specific function of the wearable device 200 based on the IMU.

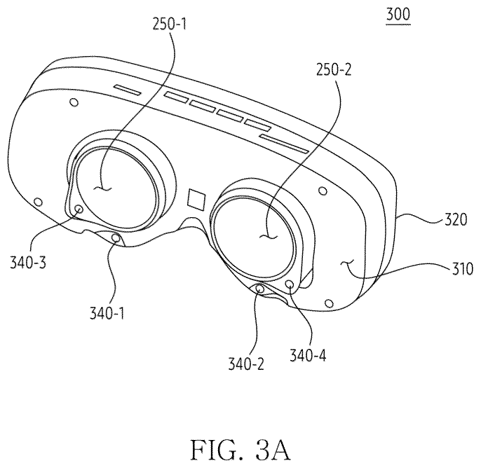

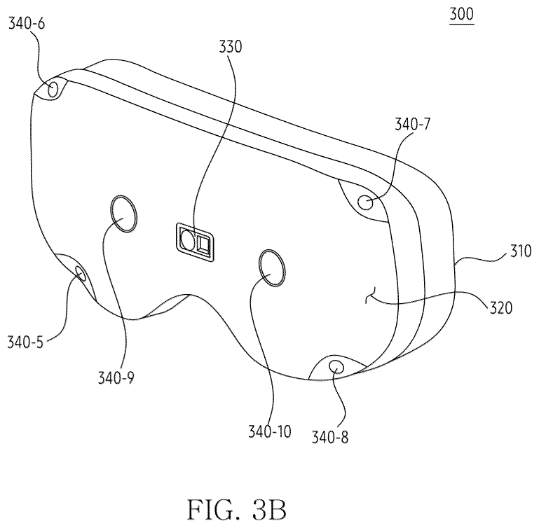

FIGS. 3A to 3B illustrate an example of an exterior of a wearable device 300 according to an embodiment. The wearable device 300 of FIGS. 3A to 3B may be included in the electronic device 101 of FIG. 1. According to an embodiment, an example of an exterior of a first surface 310 of a housing of the wearable device 300 may be illustrated in FIG. 3A, and an example of an exterior of a second surface 320 opposite to the first surface 310 may be illustrated in FIG. 3B.

Referring to FIG. 3A, according to an embodiment, the first surface 310 of the wearable device 300 may have an attachable shape on the user's body part (e.g., the user's face). Although not illustrated, the wearable device 300 may further include a strap for being fixed on the user's body part, and/or one or more temples (e.g., the first temple 204 and/or the second temple 205 of FIGS. 2A to 2B). A first display 250-1 for outputting an image to the left eye among the user's two eyes and a second display 250-2 for outputting an image to the right eye among the user's two eyes may be disposed on the first surface 310. The wearable device 300 may further include rubber or silicon packing, which are formed on the first surface 310, for preventing interference by light (e.g., ambient light) different from the light emitted from the first display 250-1 and the second display 250-23.

According to an embodiment, the wearable device 300 may include cameras 340-1 and 340-2 for photographing and/or tracking two eyes of the user adjacent to each of the first display 250-1 and the second display 250-2. The cameras 340-1 and 340-2 may be referred to as ET camera. According to an embodiment, the wearable device 300 may include cameras 340-3 and 340-4 for photographing and/or recognizing the user's face. The cameras 340-3 and 340-4 may be referred to as a FT camera.

Referring to FIG. 3B, a camera (e.g., cameras 340-5, 340-6, 340-7, 340-8, 340-9, and 340-10), and/or a sensor (e.g., the depth sensor 330) for obtaining information associated with the external environment of the wearable device 300 may be disposed on the second surface 320 opposite to the first surface 310 of FIG. 3A. For example, the cameras 340-5, 340-6, 340-7, 340-8, 340-9, and 340-10 may be disposed on the second surface 320 in order to recognize an external object distinct from the wearable device 300. For example, by using cameras 340-9 and 340-10, the wearable device 300 may obtain an image and/or video to be transmitted to each of the user's two eyes. The camera 340-9 may be disposed on the second surface 320 of the wearable device 300 to obtain an image to be displayed through the second display 250-2 corresponding to the right eye among the two eyes. The camera 340-10 may be disposed on the second surface 320 of the wearable device 300 to obtain an image to be displayed through the first display 250-1 corresponding to the left eye among the two eyes.

According to an embodiment, the wearable device 300 may include the depth sensor 330 disposed on the second surface 320 in order to identify a distance between the wearable device 300 and the external object. By using the depth sensor 330, the wearable device 300 may obtain spatial information (e.g., a depth map) about at least a portion of the FoV of the user wearing the wearable device 300.

Although not illustrated, a microphone for obtaining sound outputted from the external object may be disposed on the second surface 320 of the wearable device 300. The number of microphones may be one or more according to embodiments.

As described above, according to an embodiment, the wearable device 300 may have a form factor to be worn on a head of the user. The wearable device 300 may provide a user experience based on augmented reality, virtual reality, and/or mixed reality in a state of being worn on the head. Using the cameras 340-5, 340-6, 340-7, 340-8, 340-9, and 340-10 for recording video of an external space, the wearable device 300 and a server (e.g., the server 110 of FIG. 1) connected to the wearable device 300 may provide an on-demand service and/or a metaverse service that provides video of a location and/or a place selected by the user.

According to an embodiment, the wearable device 300 may display frames obtained via the cameras 340-9 and 340-10 on each of the second display 250-2 and the first display 250-1. The wearable device 300 may provide the user with a user experience (e.g., video see-through (VST)) in which a real object and a virtual object are mixed by combining a virtual object in a frame including a real object, the frame being displayed via the first display 250-1 and the second display 250-2. The wearable device 300 may change the virtual object based on information obtained by the cameras 340-1, 340-2, 340-3, 340-4, 340-5, 340-6, 340-7, and 340-8, and/or the depth sensor 330. For example, in a case in which a visual object corresponding to the real object and the virtual object are at least partially overlapped in the frame, the wearable device 300 may cease displaying the virtual object based on detecting a motion for interacting with the real object. By ceasing the display of the virtual object, the wearable device 300 may prevent degradation of visibility of the real object as the visual object corresponding to the real object is occluded by the virtual object.

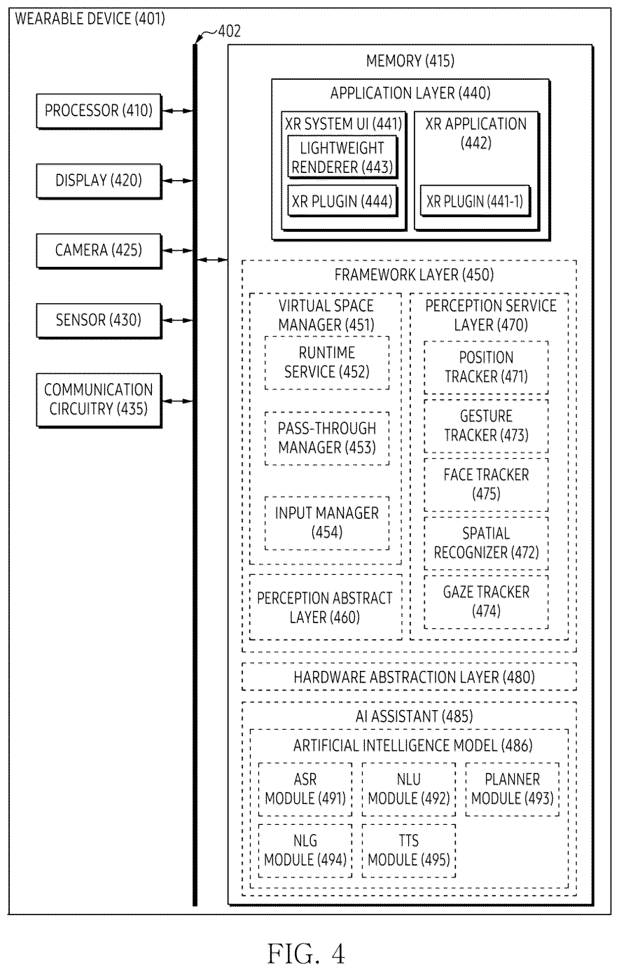

FIG. 4 illustrates an example of a block diagram of a wearable device 401 according to an embodiment. The wearable device 401 of FIG. 4 may correspond to the electronic device 101 of FIG. 1. The wearable device 401 of FIG. 4 may correspond to the wearable device 200 of FIG. 2A or FIG. 2B. The wearable device 401 of FIG. 4 may correspond to the wearable device 300 of FIG. 3.

Referring to FIG. 4, the wearable device 401 according to an embodiment may include at least one of a processor 410, memory 415, a display 420, a camera 425, a sensor 430, or communication circuitry 435. The processor 410 of FIG. 4 may correspond to the processor 120 of FIG. 1. The memory 415 of FIG. 4 may correspond to the memory 130 of FIG. 1. The display 420 of FIG. 4 may correspond to the display module 160 of FIG. 1. The camera 425 of FIG. 4 may correspond to the camera module 180 of FIG. 1. The sensor 430 of FIG. 4 may correspond to the sensor module 176 of FIG. 1. The communication circuitry 435 of FIG. 4 may correspond to the communication module 190 of FIG. 1.

The processor 410, the memory 415, the display 420, the camera 425, the sensor 430, and the communication circuitry 435 may be electronically and/or operably coupled with each other by an electronic component such as a communication bus 402. A type and/or the number of hardware components included in the wearable device 401 are not limited to those illustrated in FIG. 4. For example, the wearable device 401 may include only a portion of the hardware components illustrated in FIG. 4. Elements (e.g., layers and/or modules) in the memory described below may be logically separated. However, the present disclosure is not limited to the above example elements.

The processor 410 of the wearable device 401 according to an embodiment may include a hardware component for processing data based on one or more instructions. The hardware component for processing data may include, for example, an arithmetic and logic unit (ALU), a field programmable gate array (FPGA), and/or a central processing unit (CPU). The number of the processor 410 may be one or more. For example, the processor 410 may have a structure of a multi-core processor such as a dual core, a quad core, or a hexa core.

The memory 415 of the wearable device 401 according to an embodiment may include a hardware component for storing data and/or instructions input to and/or output from the processor 410. The memory 415 may include, for example, volatile memory such as random-access memory (RAM) and/or non-volatile memory such as read-only memory (ROM). The volatile memory may include, for example, at least one of dynamic RAM (DRAM), static RAM (SRAM), Cache RAM, or pseudo SRAM (PSRAM). The non-volatile memory may include, for example, at least one of programmable ROM (PROM), erasable PROM (EPROM), electrically erasable PROM (EEPROM), flash memory, a hard disk, a compact disk, or an embedded multimedia card (eMMC).

In an embodiment, the display 420 of the wearable device 401 may output visualized information to a user of the wearable device 401. For example, the display 420 may output visualized information to the user by being controlled by the processor 410 including a circuit such as a graphic processing unit (GPU). The display 420 may include a flat panel display (FPD) and/or electronic paper. The FPD may include a liquid crystal display (LCD), a plasma display panel (PDP), and/or at least one or more light emitting diodes (LEDs). The LED may include an organic LED (OLED).

In an embodiment, the camera 425 of the wearable device 401 may include one or more optical sensors (e.g., a charged coupled device (CCD) sensor or a complementary metal oxide semiconductor (CMOS) sensor) that generate an electrical signal indicating color and/or brightness of light. A plurality of optical sensors included in the camera 425 may be disposed in a form of a 2-dimensional array. The camera 425 may generate 2-dimensional frame data corresponding to light that has reached the optical sensors of the 2-dimensional array by substantially simultaneously obtaining electrical signals from each of the plurality of optical sensors. For example, photo data captured using the camera 425 may be or correspond to a 2-dimensional frame data obtained from the camera 425. For example, video data captured using the camera 425 may be or correspond to a sequence of a plurality of 2-dimensional frame data obtained from the camera 425 according to a frame rate. The camera 425 may further include a flash light that is disposed toward a direction in which the camera 425 receives light and outputs light toward the direction.

According to an embodiment, the wearable device 401 may include a plurality of cameras disposed toward different directions, as an example of the camera 425. Among the plurality of cameras, a first camera may be referred to as an operation recognition camera (e.g., the operation recognition cameras 260-2 and 260-3 of FIG. 2B), and a second camera may be referred to as an eye tracking camera (e.g., the eye tracking camera 260-1 of FIG. 2B). The wearable device 401 may identify a position, shape, and/or gesture of a hand using an image obtained by using the first camera. The wearable device 401 may identify a direction of a gaze of the user wearing the wearable device 401 using an image obtained by using the second camera. As an example, a direction toward which the first camera faces and a direction toward which the second camera faces may be opposite.

According to an embodiment, the sensor 430 of the wearable device 401 may generate electronic information, and may be processed by the processor 410 and/or the memory 415 of the wearable device 401, from non-electronic information associated with the wearable device 401. The information may be referred to as sensor data. The sensor 430 may include a global positioning system (GPS) sensor for detecting a geographic location of the wearable device 401, an image sensor, an illuminance sensor, and/or a time-of-flight (ToF) sensor, and an inertial measurement unit (IMU) for detecting physical motion of the wearable device 401.

In an embodiment, the communication circuitry 435 of the wearable device 401 may include a hardware component for supporting transmission and/or reception of an electrical signal between the wearable device 401 and an external electronic device. The communication circuitry 435 may include, for example, at least one of a MODEM, an antenna, or an optic/electronic (O/E) converter. The communication circuitry 435 may support transmission and/or reception of an electrical signal based on various types of protocols such as Ethernet, local area network (LAN), wide area network (WAN), wireless fidelity (Wi-Fi), Bluetooth™, Bluetooth low energy (BLE), ZigBee, long term evolution (LTE), 5G new radio (NR), and/or 6G.

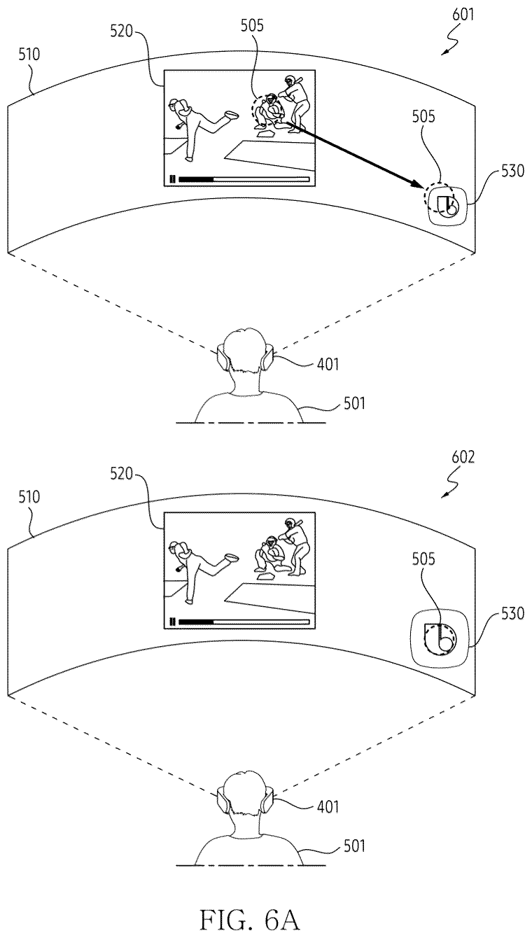

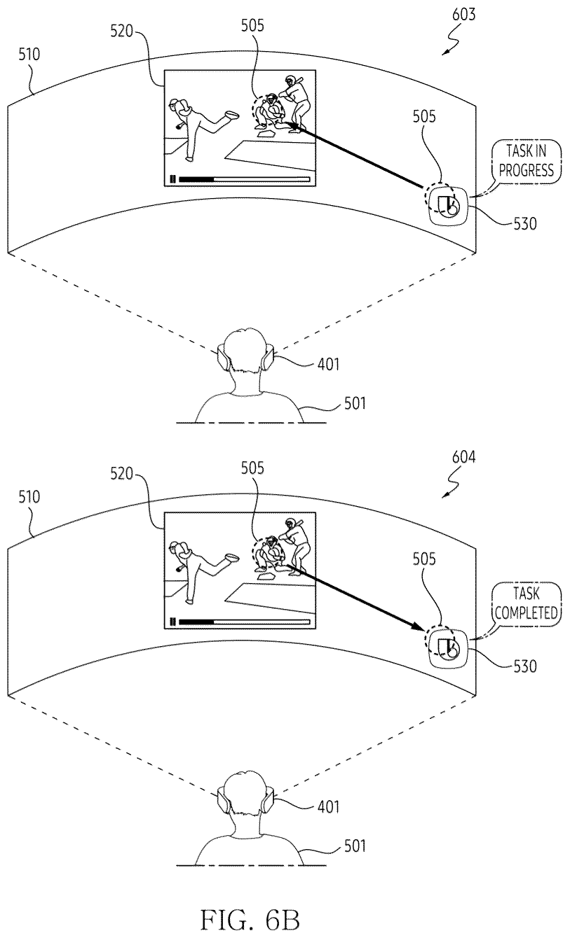

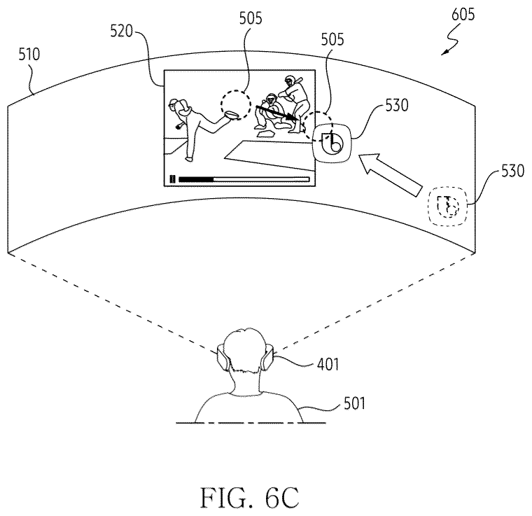

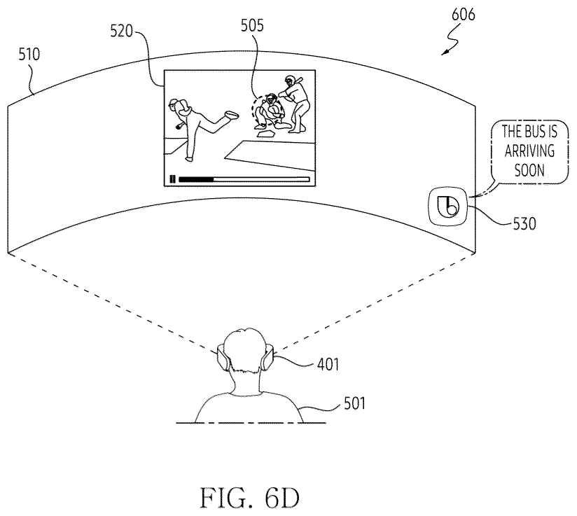

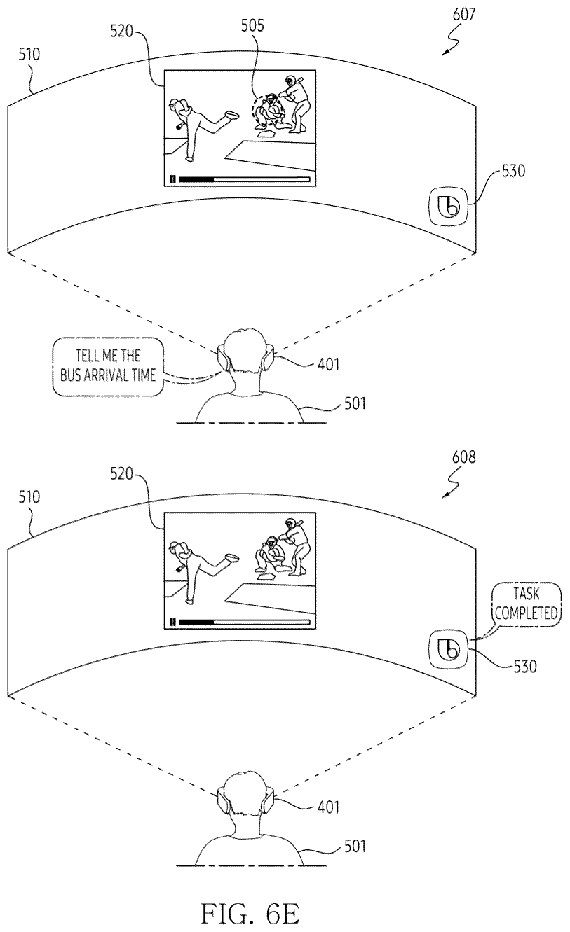

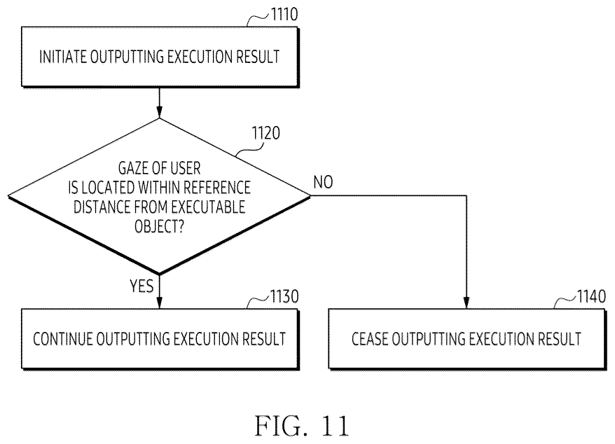

According to an embodiment, one or more instructions (or commands) indicating a computation and/or an operation to be performed on data by the processor 410 of the wearable device 401 may be stored in the memory 415 of the wearable device 401. A set of one or more instructions may be referred to as firmware, an operating system, a process, a routine, a sub-routine, and/or an application. For example, the wearable device 401 and/or the processor 410 may perform at least one of operations of FIG. 6 or FIG. 11 when a set of a plurality of instructions distributed in a form of an operating system, firmware, a driver, and/or an application is executed. Hereinafter, an application is installed in the wearable device 401. In other words, one or more instructions are provided in a form of an application are stored in the memory 415, and the one or more applications are stored in a format (e.g., a file having an extension designated by an operating system of the wearable device 401) executable by the processor 410. As an example, the application may include a program and/or library associated with a service provided to the user.

Referring to FIG. 4, programs installed in the wearable device 401 may be classified into any one of different layers including an application layer 440, a framework layer 450, and/or a hardware abstraction layer (HAL) 480 based on a target. For example, in the hardware abstraction layer 480, programs (e.g., modules or drivers) designed to target hardware of the wearable device 401 (e.g., the display 420, the camera 420, and/or the sensor 430) may be classified. The framework layer 450 may be referred to as an XR framework layer in that it includes one or more programs for providing an extended reality (XR) service. For example, although FIG. 4 illustrates the layers as being separated in the memory 415, the layers may be logically separated. However, the present disclosure is not limited to the above example elements. According to an embodiment, the layers may also be stored in a designated area in the memory 415.

For example, in the framework layer 450, programs (e.g., a position tracker 471, a spatial recognizer 472, a gesture tracker 473, a gaze tracker 474, and/or a face tracker 475) designed to target at least one of the hardware abstraction layer 480 and/or the application layer 440 may be classified. Programs classified as the framework layer 450 may provide an application programming interface (API) executable based on another program.

For example, in the application layer 440, a program designed to target the user controlling the wearable device 401 may be classified. As an example of programs classified as the application layer 440, an extended reality (XR) system user interface (UI), and/or an XR application 442 is exemplified, but the present disclosure is not limited to the above example elements. For example, programs (e.g., software applications) classified as the application layer 440 may cause execution of a function supported by the programs classified as the framework layer 450 by calling an application programming interface (API).

For example, the wearable device 401 may display on the display 420 one or more visual objects for performing interaction with a user for using a virtual space, based on execution of an XR system UI 441. A visual object may be or correspond to an object deployable in a screen for transmission of information and/or interaction, such as text, image, icon, video, button, checkbox, radio button, text box, slider, and/or table. A visual object may be referred to as a visual guide, a virtual object, a visual element, a UI element, a view object, and/or a view element. The wearable device 401 may provide the user with a service for controlling functions available in the virtual space, based on the execution of the XR system UI 441.

FIG. 4 illustrates that a lightweight renderer 443 and/or an XR plugin 444 are included in the XR system UI 441, but the present disclosure is not limited to the above example elements. For example, the XR system UI 441 may cause execution of a function supported by the lightweight renderer 443 and/or the XR plugin 444 included in the framework layer 450.

For example, the wearable device 401 may obtain a resource (e.g., API, system process, and/or library) used to define, generate, and/or execute a rendering pipeline allowing partial changes, based on execution of a lightweight renderer 443. The lightweight renderer 443 may be referred to as a lightweight render pipeline in terms of defining a rendering pipeline allowing partial changes. The lightweight renderer 443 may include a renderer built before execution of a software application (e.g., a prebuilt renderer). For example, the wearable device 401 may obtain a resource (e.g., API, system process, and/or library) used to define, generate, and/or execute an entire rendering pipeline, based on execution of the XR plugin 444. The XR plugin 444 may be referred to as an open XR native client in terms of defining (or setting) an entire rendering pipeline.

For example, the wearable device 401 may display a screen indicating at least a portion of a virtual space on the display 420, based on execution of the XR application 442. An XR plugin 444-1 included in the XR application 442 may be referenced to the XR plugin 444 of the XR system UI 441. A description of the XR plugin 444-1 overlapping with a description of the XR plugin 444 may be omitted. The wearable device 401 may cause execution of a virtual space manager 451, based on the execution of the XR application 442.

According to an embodiment, the wearable device 101 may provide a virtual space service based on execution of the virtual space manager 451. For example, the virtual space manager 451 may include a platform (e.g., Android platform) for supporting the virtual space service. The wearable device 401 may display on the display a posture of a virtual object indicating a posture of a user, which is rendered using data obtained via the sensor 430, based on the execution of the virtual space manager 451. The virtual space manager 451 may be referred to as a composition presentation manager (CPM).

For example, the virtual space manager 451 may include a runtime service 452. As an example, the runtime service 452 may be referred to as an OpenXR runtime module. The wearable device 401 may be used to provide at least one of a user pose prediction function, a frame timing function, and/or a spatial input function via the wearable device 401, based on execution of the runtime service 452. As an example, the wearable device 401 may be used to perform rendering for a virtual space service for the user, based on the execution of the runtime service 452. For example, an application (e.g., a Unity or an OpenXR native application) may be implemented based on the execution of the runtime service 452.

For example, the virtual space manager 451 may include a pass-through manager 453. While displaying a screen indicating a virtual space on the display 420, the wearable device 401 may overlappingly display another screen indicating real space obtained via the camera 425 on at least a portion of the screen, based on execution of the pass-through manager 453.

For example, the virtual space manager 451 may include an input manager 454. The wearable device 401 may identify data (e.g., sensor data) obtained by executing one or more programs included in a perception service layer 470, based on execution of the input manager 454. The wearable device 401 may initiate execution of at least one of functions of the wearable device 401 by using the obtained data.

For example, a perception abstract layer 460 may be used for data exchange between the virtual space manager 451 and the perception service layer 470. In terms of being used for data exchange between the virtual space manager 451 and the perception service layer 470, the perception abstract layer 460 may be referred to as an interface. As an example, the perception abstract layer 460 may be referred to as OpenPX. The perception abstract layer 460 may be used for a perception client and a perception service.

According to an embodiment, the perception service layer 470 may include one or more programs for processing data obtained from the sensor 430 (or the camera 425). The one or more programs may include at least one of the position tracker 471, the spatial recognizer 472, the gesture tracker 473, the gaze tracker 474, and/or the face tracker 475. A type and/or the number of the one or more programs included in the perception service layer 470 are not limited to those illustrated in FIG. 4.

For example, the wearable device 401 may identify a pose of the wearable device 401 using the sensor 430, based on execution of the position tracker 471. The wearable device 401 may identify a 6 degrees of freedom pose (6 dof pose) of the wearable device 401 using data obtained via the camera 425 and an IMU, based on the execution of the position tracker 471. The position tracker 471 may be referred to as a head tracking (HeT) module.

For example, the wearable device 401 may be used to configure a surrounding environment of the wearable device 401 (or the user of the wearable device 401) into a 3-dimensional virtual space, based on execution of the spatial recognizer 472. The wearable device 401 may reconstruct the surrounding environment of the wearable device 401 in three dimensions using data obtained via the camera 425, based on the execution of the spatial recognizer 472. The wearable device 401 may identify at least one of a plane, a slope, or stairs based on the surrounding environment of the wearable device 401 reconstructed in three dimensions based on the execution of the spatial recognizer 472. The spatial recognizer 472 may be referred to as a scene understanding (SU) module.

For example, the wearable device 401 may be used to identify (or recognize) a pose and/or a gesture of a hand of the user of the wearable device 401, based on execution of the gesture tracker 473. As an example, the wearable device 401 may identify the pose and/or the gesture of the hand of the user by using data obtained from the sensor 430, based on the execution of the gesture tracker 473. As an example, the wearable device 401 may identify the pose and/or the gesture of the hand of the user based on data (or image) obtained using a camera, based on the execution of the gesture tracker 473. The gesture tracker 473 may be referred to as a hand tracking (HaT) module and/or a gesture tracking module.

For example, the wearable device 401 may identify (or track) movement of an eye of the user of the wearable device 401, based on execution of the gaze tracker 474. As an example, the wearable device 401 may identify movement of the eye of the user using data obtained from at least one sensor, based on the execution of the gaze tracker 474. As an example, the wearable device 401 may identify movement of the eye of the user based on data obtained using a camera (e.g., the eye tracking camera 260-1 of FIGS. 2A and 2B) and/or an infrared light emitting diode (IR LED), based on the execution of the gaze tracker 474. The gaze tracker 474 may be referred to as an eye tracking (ET) module and/or a gaze tracking module.

For example, the perception service layer 470 of the wearable device 401 may further include a face tracker 475 for tracking a face of the user. For example, the wearable device 103 may identify (or track) movement of the face of the user and/or a facial expression of the user, based on execution of the face tracker 475. The wearable device 401 may estimate the facial expression of the user based on movement of the face of the user, based on the execution of the face tracker 475. As an example, the wearable device 401 may identify movement of the face of the user and/or the facial expression of the user based on data (e.g., image) obtained using the camera, based on the execution of the face tracker 475.

The memory 415 may include an artificial intelligence (AI) assistant 485. The AI assistant 485 may be included in the application layer 440 and/or the framework layer 450. Herein, the AI assistant 485 may also be referred to as an AI voice recognition model. The AI assistant 485 may also be referred to as an AI program and/or an AI module.

The AI assistant 485 may include an artificial intelligence model 486 for interpreting an intent of an input of the user. The AI assistant 485 may include the artificial intelligence model 486 for establishing a plan corresponding to the intent. The AI assistant 485 may include the artificial intelligence model 486 for providing a result generated according to the plan corresponding to the intent to the user. The AI assistant 485 may include an automatic speech recognition (ASR) module 491, a natural language understanding (NLU) module 492, a planner module 493, a natural language generator (NLG) module 494, and a text to speech (TTS) module 495. Herein, the input of the user may include voice input. However, the present disclosure is not limited to the above example elements. For example, the input of the user may include text input.

According to an embodiment, the automatic speech recognition module 491 may convert an input obtained from the wearable device 401 into text data. According to an embodiment, the natural language understanding module 492 may identify an intent of the user by using the text data of the input. For example, the natural language understanding module 492 may identify the intent of the user by performing syntactic analysis or semantic analysis. According to an embodiment, the natural language understanding module 492 may determine the intent of the user by identifying the meaning of a word extracted from the text data of the input using linguistic features of a morpheme or a phrase (e.g., grammatical elements) and matching the identified meaning of the word to the intent.

According to an embodiment, the planner module 493 may generate a plan by using parameters and the intent determined by the natural language understanding module 492. According to an embodiment, the planner module 493 may determine a plurality of domains required to perform a task based on the determined intent. The planner module 493 may determine a plurality of operations included in each of the plurality of domains determined based on the intent. According to an embodiment, the planner module 493 may determine parameters required to execute the determined plurality of operations or result values output by execution of the plurality of operations. The parameters and the result values may be defined as concepts associated with a designated format (or class). Accordingly, the plan may include the plurality of concepts and the plurality of operations determined by the intent of the user. The planner module 493 may determine relationships between the plurality of operations and the plurality of concepts in a stepwise (or hierarchical) manner. For example, the planner module 493 may determine an execution order of the plurality of operations determined based on the intent of the user, based on the plurality of concepts. In other words, the planner module 493 may determine the execution order of the plurality of operations based on the parameters required for execution of the plurality of operations and the results output by execution of the plurality of operations. Accordingly, the planner module 493 may generate a plan including association information (e.g., ontology) between the plurality of operations and the plurality of concepts. The planner module 493 may generate the plan using information stored in a capsule database in which a set of relationships between concepts and operations is stored.

According to an embodiment, the natural language generator module 494 may convert designated information into text form. The information converted into the text form may be in a form of a natural language utterance. The text to speech module 495 of an embodiment may convert the information in the text form into information in speech form.

According to an embodiment, at least a portion of functions of the AI assistant 485 may be performed externally (e.g., by a server 108). For example, at least one function executed by at least one module among the automatic speech recognition module 491, the natural language understanding module 492, the planner module 493, the natural language generator module 494, or the text to speech module 495 of the AI assistant 485 may be performed externally (e.g., by the server 108). In a case in which at least a portion of the functions of the AI assistant 485 is performed externally (e.g., by the server 108), the wearable device 401 may request execution of at least a portion of functions of the wearable device 401 to the external entity (e.g., the server 108) and may obtain an execution result of at least a portion of the functions.

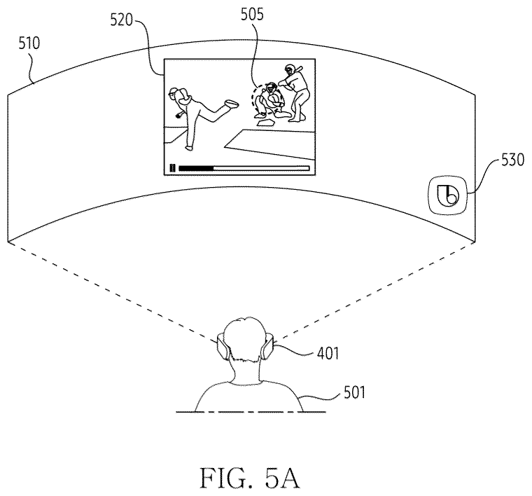

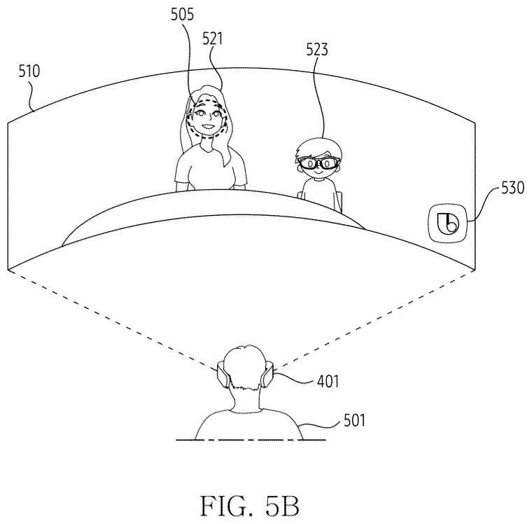

FIG. 5A illustrates an example of a field-of-view (FOV) 510 of a user 501 wearing a wearable device 401 in an embodiment. FIG. 5B illustrates an example of a situation in which input of a user wearing a wearable device is obtained in an embodiment.

The wearable device 401 of FIGS. 5A and 5B may correspond to the electronic device 101 of FIG. 1. The wearable device 401 of FIGS. 5A and 5B may correspond to the wearable device 200 of FIGS. 2A and 2B. The wearable device 401 of FIGS. 5A and 5B may correspond to the wearable device 300 of FIGS. 3A and 3B. The wearable device 401 of FIGS. 5A and 5B may correspond to the wearable device 401 of FIG. 4. FIGS. 5A and 5B may be described with reference to FIGS. 1, 2A, 2B, 3A, 3B, and 4.

Referring to FIG. 5A, the user 501 may wear the wearable device 401. The user 501 may view at least one content 520 within the FOV 510 via the wearable device 401. Herein, the FOV 510 may be or correspond to a region viewable by the user 501. The FOV 510 may be or correspond to a display region of the wearable device 401 viewable by the user 501. The FOV 510 may include one or more regions in which the at least one content 520 is displayed.

A processor 410 of the wearable device 401 may display the at least one content 520 via a display 420. Herein, the at least one content 520 may be displayed as a stereoscopic image on the display 420. The stereoscopic image may be an image considering binocular disparity of the user 501. The stereoscopic image may be an image for providing a three dimensional (3D) spatial sense to the user 501. Herein, the at least one content 520 may indicate an execution result of an application. The at least one content 520 may reflect real space. Herein, “reflecting real space” may mean that the at least one content 520 existing in real space may be visible to the user 501 via the display 420 via pass-through. In some embodiments, “reflecting real space” may mean that an image indicating real space obtained via a camera 425 (or a front camera 240-3, 340-9, or 340-10) via video see through (VST) and/or pass-through is provided to the user. However, the present disclosure is not limited to the above example elements. A region excluding the region of the content 520 may reflect real space. For example, the region excluding the region of the content 520 in the FOV 510 may reflect real space. For example, the region excluding the region of the content 520 in the FOV 510 may display the image indicating real space obtained via the camera 425 (or the front camera 240-3, 340-9, or 340-10).

The processor 410 may display a visual object 530 associated with an AI assistant 485.

The processor 410 may display the visual object 530 associated with the AI assistant 485 at a designated position. The processor 410 may display the visual object 530 at the designated position before the user 501 calls the AI assistant 485. However, the present disclosure is not limited to the above example elements. The processor 410 may not display the visual object 530 associated with the AI assistant 485. The processor 410 may not display the visual object 530 associated with the AI assistant 485 before the user 501 calls the AI assistant 485. The processor 410 may display the visual object 530 associated with the AI assistant 485 after the user 501 calls the AI assistant 485. Hereinafter, the visual object 530 associated with the AI assistant 485 may be referred to as an AI object 530.

For example, the processor 410 may display the visual object 530 associated with the AI assistant 485 at a fixed position within the FOV 510. Herein, ‘displaying at a fixed position within the FOV 510’ may mean that the visual object 530 is displayed at a specific position even when the user 501 moves (e.g., even when the user 501 turns their head). Fixing the visual object 530 at a fixed position within the FOV 510 may also be referred to as body lock.

For example, the processor 410 may display the visual object 530 associated with the AI assistant 485 at a fixed position on a coordinate based on (or centered around, or originating from) the user 501. Herein, ‘displaying at a fixed position on the coordinate based on the user 501’ may mean that a display position of the visual object 530 changes according to movement (and/or rotation) of the user 501. Displaying at a fixed position on the coordinate based on the user 501 may also be referred to as ‘world lock’.

The processor 410 may identify (or track) a gaze 505. For example, the processor 410 may identify (or track) movement of an eye of the user 501 of the wearable device 401 based on execution of a gaze tracker 474. The processor 410 may identify a region of interest (ROI) based on the gaze 505. Herein, the region of interest may be a region on the FOV 510 in which the gaze 505 of the user 501 is located.

The processor 410 may process user input. The processor 410 may process user input based on an object where the gaze 505 of the user 501 is located. For example, the processor 410 may process user input via an application associated with the object where the gaze 505 of the user 501 is located. Herein, the user input may include voice of the user obtained via a microphone included in an input module 150. However, the present disclosure is not limited to the above example elements. For example, the user input may include gesture input obtained via a gesture tracker 473. The user input may be obtained via the input module 150 (e.g., a microphone, a mouse, a keyboard, a key (e.g., a button), or a digital pen (e.g., a stylus pen)).

Referring to FIG. 5B, in a case in which the gaze 505 of the user 501 is located on another visual object 521 or 523, which is distinguished from the AI object 530, the processor 410 may process user input via an application associated with the other visual object 521 or 523. For example, in a case in which the other visual object 521 or 523 is an avatar of another user, the processor 410 may process user input via an application for interaction with the other user. For example, the processor 410 may process user input via an application for voice chat and/or a call (or a conference call) with a user of the other visual object 521. For example, the processor 410 may provide a voice chat service with the user of the other visual object 521 to the user of the wearable device 401 via the application for voice chat, in response to user input requesting voice chat with the user of the other visual object 521 while the gaze 505 of the user 501 is located on the other visual object 521.

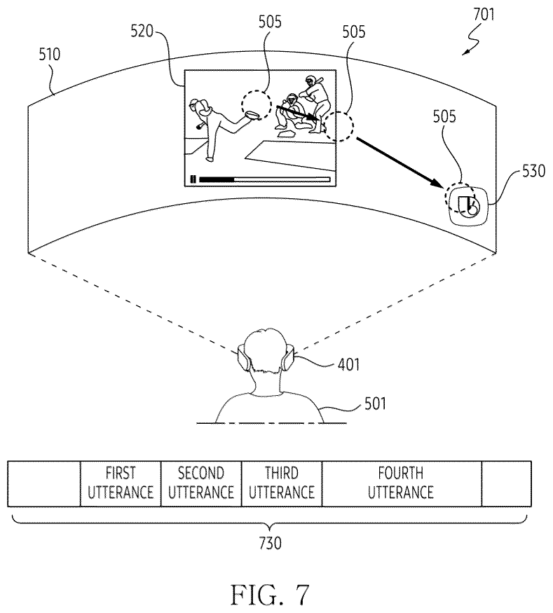

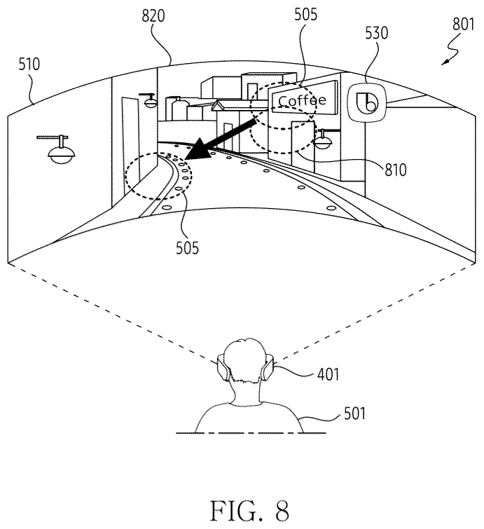

The processor 410 may identify an interaction with the AI object 530 by the gaze 505 of the user 501. In a case in which the gaze 505 of the user 501 is located on the AI object 530, the processor 410 may process user input via an application associated with the AI object 530. Hereinafter, operations performed by the processor 410 according to the interaction with the AI object 530 by the gaze 505 will be described with reference to FIG. 6A, FIG. 6B, FIG. 6C, FIG. 6D, FIG. 7, FIG. 8A, and FIG. 8B.

FIG. 6A illustrates an example of screens displayed by a wearable device 401 in an embodiment.

The wearable device 401 of FIG. 6A may correspond to the electronic device 101 of FIG. 1. The wearable device 401 of FIG. 6A may correspond to the wearable device 200 of FIGS. 2A and 2B. The wearable device 401 of FIG. 6A may correspond to the wearable device 300 of FIGS. 3A and 3B. The wearable device 401 of FIG. 6A may correspond to the wearable device 401 of FIG. 4. FIG. 6A may be described with reference to FIGS. 1, 2A, 2B, 3A, 3B, and 4.

Referring to situation 601 of FIG. 6A, a processor 410 may identify that a gaze 505 of a user 501 has moved. The processor 410 may identify that the gaze 505 of the user 501 has moved based on execution of a gaze tracker 474.

For example, the processor 410 may identify that the gaze 505 of the user 501 has moved from a content 520 to an AI object 530. For example, the processor 410 may identify that the gaze 505 of the user 501 directed toward the content 520 has moved to the AI object 530. For example, the processor 410 may identify that the gaze 505 of the user 501 is directed toward the AI object 530. For example, the processor 410 may identify that a region of interest of the user 501 has moved from the content 520 to the AI object 530 as the gaze moves.

Referring to situation 602 of FIG. 6A, the processor 410 may change display of the AI object 530 based on the gaze 505 of the user 501 being directed toward the AI object 530. For example, the processor 410 may enlarge a size of the AI object 530 based on the gaze 505 of the user 501 being directed toward the AI object 530. However, the present disclosure is not limited to the above example elements. The processor 410 may apply an image effect (e.g., sparkle) to the AI object 530 based on the gaze 505 of the user 501 being directed toward the AI object 530. The processor 410 may change attributes (e.g., shape or color) of a surrounding area of the AI object 530. The processor 410 may change attributes (e.g., shape or color) of the AI object 530.

The processor 410 may obtain input of the user 501 based on the gaze 505 of the user 501 being directed toward the AI object 530. The processor 410 may obtain voice input of the user 501 based on the gaze 505 of the user 501 being directed toward the AI object 530. For example, the processor 410 may obtain the voice input of the user 501 via a microphone included in an input module 150. However, the present disclosure is not limited to the above example elements.

FIG. 6B illustrates an example of a screen displayed by the wearable device 401 in an embodiment.

The wearable device 401 of FIG. 6B may correspond to the electronic device 101 of FIG. 1. The wearable device 401 of FIG. 6B may correspond to the wearable device 200 of FIGS. 2A and 2B. The wearable device 401 of FIG. 6B may correspond to the wearable device 300 of FIGS. 3A and 3B. The wearable device 401 of FIG. 6B may correspond to the wearable device 401 of FIG. 4. FIG. 6B may be described with reference to FIGS. 1, 2A, 2B, 3A, 3B, and 4.

Situations 603 and 604 of FIG. 6B may exemplify situations following the situations 601 and 602 of FIG. 6A.

The processor 410 may activate an AI assistant 485 based on the gaze 505 of the user 501 being directed toward the AI object 530. Herein, ‘activating the AI assistant 485’ may mean executing the AI assistant 485. ‘Activating the AI assistant 485’ may mean that input (e.g., voice input) of the user 501 is delivered to the AI assistant 485.

For example, the processor 410 may obtain input “Please check if the attendees for tomorrow's meeting are available” via the input module 150. Herein, the input may include at least one of text input or voice input.

The processor 410 may identify an intent of the user 501 via the AI assistant 485 based on the input of the user 501. The processor 410 may establish a plan corresponding to the intent of the user 501 via the AI assistant 485. The processor 410 may execute the plan established via the AI assistant 485. The processor 410 may obtain an execution result of the established plan via the AI assistant 485. Herein, the execution result may include feedback to be provided to the user 501. The feedback may include at least one of voice feedback or visual feedback. Herein, the visual feedback may be based on at least one of an image, a video, or text.

For example, the processor 410 may identify intent of the input “Please check if the attendees for tomorrow's meeting are available” via the AI assistant 485. The processor 410 may establish a plan corresponding to the intent of the input “Please check if the attendees for tomorrow's meeting are available” via the AI assistant 485. For example, the processor 410 may identify the attendees for tomorrow's meeting via the AI assistant 485. For example, the processor 410 may transmit a message via the AI assistant 485 to contact information (e.g., email or phone number) of each attendee for tomorrow's meeting to inquire about their availability. For example, the processor 410 may wait for reception of a response to the message via the AI assistant 485. For example, in a case in which the reception of the response is completed or a predefined response time has elapsed, the processor 410 may identify, via the AI assistant 485, whether the attendees for tomorrow's meeting are available based on the received response. For example, the processor 410 may generate an execution result including an identification result based on the response via the AI assistant 485.

The processor 410 may determine whether the input of the user 501 is sufficient. The processor 410 may determine whether the input of the user 501 is sufficient to establish a plan according to an intent of the user 501 via the AI assistant 485. In a case in which the input of the user 501 is insufficient, the processor 410 may provide a notification to the user 501. Herein, the notification provided to the user 501 may be different from feedback that notifies the user 501 that generation of an execution result is completed. For example, the notification provided to the user 501 may change display of the AI object 530 in a manner different from the feedback that notifies that generation of an execution result is completed.

The processor 410 may identify the intent of the user 501 via the AI assistant 485. The processor 410 may establish a plan corresponding to the intent of the user 501 via the AI assistant 485. The processor 410 may execute the plan established via the AI assistant 485. The processor 410 may obtain an execution result of the established plan via the AI assistant 485. Herein, the execution result may include feedback to be provided to the user 501. The feedback may include at least one of voice feedback or visual feedback. Herein, the visual feedback may be based on at least one of an image, a video, or text.

The processor 410 may output a notification associated with the AI assistant 485 while obtaining the execution result based on the input (e.g., voice input) of the user 501 via the AI assistant 485. For example, the processor 410 may output a notification associated with the AI assistant 485 indicating that a task is in progress. For example, the processor 410 may output a notification associated with the AI assistant 485 indicating that a task is in progress via a sound output module 155 (e.g., a speaker). For example, the processor 410 may output a notification associated with the AI assistant 485 indicating that a task is in progress via a display 420. For example, the processor 410 may output a notification associated with the AI assistant 485 indicating that a task is in progress via the sound output module 155 (e.g., the speaker) and the display 420.

Referring to the situation 603 of FIG. 6B, the processor 410 may identify that the gaze 505 of the user 501 has moved. The processor 410 may identify that the gaze 505 of the user 501 has moved based on execution of the gaze tracker 474. The processor 410 may identify that the gaze 505 of the user 501 has moved from the AI object 530 to the content 520 while obtaining the execution result based on the input (e.g., voice input) of the user 501 via the AI assistant 485. The processor 410 may identify that the gaze 505 of the user 501 has moved from the AI object 530 to the content 520 before the obtaining of the execution result based on the input of the user 501 via the AI assistant 485 is completed.

The processor 410 may restore the attributes of the AI object 530 and/or the attributes around the AI object 530 based on the gaze 505 of the user 501 being located outside the AI object 530. Herein, ‘restoring the attributes’may mean changing to have the attributes of the AI object 530 and/or the attributes around the AI object 530 as before the gaze 505 was directed toward the AI object 530.

For example, the processor 410 may identify that the execution result for the input of the user 501 is generated. For example, the processor 410 may identify that the execution result for the input of the user 501 is generated via the AI assistant 485. For example, the processor 410 may identify obtaining of data for outputting the execution result for the input of the user 501 via the AI assistant 485. The processor 410 may identify the obtaining of the execution result for the input of the user 501 after the gaze 505 of the user 501 is located outside the AI object 530. The processor 410 may identify that the obtaining of the execution result for the input of the user 501 is completed after the gaze 505 of the user 501 is located outside the AI object 530.

The processor 410 may notify the user 501 that the generation of the execution result is completed. The processor 410 may notify the user 501 that generation of feedback associated with the execution result is completed. The processor 410 may provide a notification for guiding the gaze 505 of the user 501 to the AI object 530. For example, the processor 120 may provide a notification for guiding the gaze 505 of the user 501 to the AI object 530 based on at least one of audio output, haptic output, or image output (e.g., image output including text). For example, the processor 120 may provide a notification for guiding the gaze 505 of the user 501 to the AI object 530 in different manners based on the currently displayed content 520 or a type of an application 146. For example, the processor 120 may provide a notification for guiding the gaze 505 of the user 501 to the AI object 530 according to surrounding noise or illuminance. For example, the processor 120 may provide a larger notification when the surrounding noise is loud.

Referring to the situation 604 of FIG. 6B, the processor 410 may change the display of the AI object 530 based on the generation of the execution result being completed. The processor 410 may change the display of the AI object 530 in response to identifying that the obtaining of the execution result for the input of the user 501 is completed after the gaze 505 of the user 501 is located outside the AI object 530. For example, the processor 410 may enlarge the size of the AI object 530 based on the generation of the execution result. However, the present disclosure is not limited to the above example elements.

The processor 410 may apply an image effect (e.g., sparkle) to the AI object 530 based on the execution result being generated. For example, the processor 410 may output a notification associated with the AI assistant 485 indicating that a task is completed via the display 420 based on the execution result being generated. For example, the processor 410 may output a notification associated with the AI assistant 485 indicating that a task is completed based on the execution result being generated. For example, the processor 410 may output a notification associated with the AI assistant 485 indicating that a task is completed via the sound output module 155 (e.g., the speaker) based on the execution result being generated.

The processor 410 may determine whether to output the execution result based on the execution result being generated. The processor 410 may determine whether to output the execution result in response to identifying that the obtaining of the execution result is completed. The processor 410 may determine whether to output the execution result based on the gaze 505 of the user 501. The processor 410 may determine whether to output the execution result based on whether the gaze 505 of the user 501 is located within a first reference distance from the AI object 530. Herein, the first reference distance may be or correspond to a distance at which the user 501 is recognized as interacting with the AI object 530. The first reference distance may be set according to or based on the size of the AI object 530.

In a case in which the gaze 505 of the user 501 is identified as being located outside the first reference distance from the AI object 530, the processor 410 may not output the execution result. The processor 410 may postpone outputting the execution result in response to identifying that the gaze 505 of the user 501 is located outside the first reference distance from the AI object 530.

In a case in which the gaze 505 of the user 501 is identified as being located within the first reference distance from the AI object 530, the processor 410 may output the execution result. The processor 410 may output the execution result based on the data for outputting the execution result in response to identifying that the gaze 505 of the user 501 is located within the first reference distance from the AI object 530. In a case in which the gaze 505 of the user 501 is identified as being located within the first reference distance from the AI object 530, the processor 410 may output the execution result via the sound output module 155. However, the present disclosure is not limited to the above example elements. In a case in which the gaze 505 of the user 501 is identified as being located within the first reference distance from the AI object 530, the processor 410 may output the execution result via the display 420. For example, in a case in which the gaze 505 of the user 501 is identified as being located within the first reference distance from the AI object 530, the processor 410 may output a screen indicating the execution result via the display 420. Herein, the screen indicating the execution result may indicate the execution result based on at least one of an image, a video, or text. In a case in which the gaze 505 of the user 501 is identified as being located within the first reference distance from the AI object 530, the processor 410 may output an audio signal indicating the execution result via the sound output module 155, and may output a screen indicating the execution result via the display 420.

While outputting the execution result, the processor 410 may determine whether to cease outputting the execution result. The processor 410 may determine whether to cease outputting the execution result based on the gaze 505 of the user 501. The processor 410 may determine whether to cease outputting the execution result based on whether the gaze of the user 501 is located within a second reference distance from the AI object 530. Herein, the second reference distance may be or correspond to a distance at which the user 501 is recognized as disengaging from interaction with the AI object 530. The second reference distance may be longer than the first reference distance. However, the present disclosure is not limited to the above example elements. For example, the second reference distance may be equal to the first reference distance.

The processor 410 may continue outputting the execution result based on the gaze of the user 501 being located within the second reference distance from the AI object 530.

The processor 410 may cease outputting the execution result based on the gaze of the user 501 being located outside the second reference distance from the AI object 530. The processor 410 may cease outputting the execution result based on identifying that the gaze of the user 501 is located outside the second reference distance from the AI object 530.

The processor 410 may identify remaining time for completing outputting the execution result based on the gaze of the user 501 being located outside the second reference distance from the AI object 530. The processor 410 may identify a required time for completing outputting the execution result based on the gaze of the user 501 being located outside the second reference distance from the AI object 530.

The processor 410 may continue outputting the execution result in response to the remaining time (or the required time) being equal to or less than a first reference time. The processor 410 may continue outputting the execution result based on the gaze of the user 501 being located outside the second reference distance from the AI object 530, and the remaining time (or the required time) being equal to or less than the first reference time. However, the present disclosure is not limited to the above example elements.

The processor 410 may cease outputting the execution result in response to the remaining time (or the required time) exceeding the first reference time. The processor 410 may cease outputting the execution result based on the gaze of the user 501 being located outside the second reference distance from the AI object 530, and the remaining time (or the required time) exceeding the first reference time.

While output of the execution result has been ceased, the processor 410 may determine whether to resume outputting the execution result. The processor 410 may determine whether to resume outputting the execution result based on the gaze of the user 501. The processor 410 may determine whether to resume outputting the execution result based on whether the gaze of the user 501 is located within the first reference distance from the AI object 530.

After output of the execution result has been ceased, the processor 410 may resume outputting the execution result based on identifying that the gaze of the user 501 is located within the first reference distance from the AI object 530. Herein, ‘resuming outputting the execution result’ may mean outputting again from a portion where outputting the execution result was ceased. ‘Resuming outputting the execution result’ may mean newly initiating output of the execution result.

The processor 410 may resume outputting the execution result based on an elapsed time from a time point when outputting the execution result was ceased. The processor 410 may output again from the portion where outputting the execution result was ceased in response to the elapsed time from the time point when outputting the execution result was ceased being within a second reference time. The processor 410 may output the execution result based on the point where outputting the execution result was ceased in response to the elapsed time from the time point when outputting the execution result was ceased being within the second reference time. The processor 410 may output the execution result from the beginning in response to the elapsed time from the time point when outputting the execution result was ceased exceeding the second reference time. However, the present disclosure is not limited to the above example elements. The processor 410 may generate data summarizing the previously output portion and may output the generated data in response to the elapsed time from the time point when outputting the execution result was ceased being within the second reference time. After outputting the generated data, the processor 410 may output again from the portion where outputting the execution result was ceased. Herein, a length of time required to output data summarizing the previously output portion may increase based on the elapsed time from the time point of cessation. The processor 410 may output again from a predetermined time before the ceased portion in response to the elapsed time from the time point when outputting the execution result was ceased being within the second reference time. Herein, the predetermined time may increase based on the elapsed time from the time point of cessation.

As described above, the wearable device 401 may provide the execution result at a time point desired by the user 501 by ceasing outputting the execution result while the user 501 has ceased interaction with the AI object 530 (e.g., while the user 501 is not looking at the AI object 530).

As described above, the wearable device 401 may prevent a situation in which information needed by the user 501 is not delivered to the user 501 by providing an output result based on urgency of outputting the execution result, while the user 501 has ceased interaction with the AI object 530 (e.g., while the user 501 is not looking at the AI object 530).

As described above, the wearable device 401 may provide the AI assistant 485 with improved usability to the user 501 by providing the execution result to the user 501 via interaction based on the gaze 505 between the user 501 and the AI object 530.

FIG. 6C illustrates an example of a screen displayed by a wearable device 401 in an embodiment.

The wearable device 401 of FIG. 6C may correspond to the electronic device 101 of FIG. 1. The wearable device 401 of FIG. 6C may correspond to the wearable device 200 of FIGS. 2A and 2B. The wearable device 401 of FIG. 6C may correspond to the wearable device 300 of FIGS. 3A and 3B. The wearable device 401 of FIG. 6C may correspond to the wearable device 401 of FIG. 4. FIG. 6C may be described with reference to FIGS. 1, 2A, 2B, 3A, 3B, and 4.

Situation 605 of FIG. 6C may exemplify situations following the situations 601 and 602 of FIG. 6A. For example, the situation 605 of FIG. 6C may exemplify situations after the processor 410 obtains the input (e.g., voice input) of the user 501 via the AI assistant 485.

The processor 410 may identify that an execution result for the input of the user 501 is generated. For example, the processor 410 may identify that the execution result for the input of the user 501 is generated via the AI assistant 485. For example, the processor 410 may identify the obtaining of data for outputting the execution result for the input of the user 501 via the AI assistant 485. The processor 410 may identify the obtaining of the execution result for the input of the user 501 after the gaze 505 of the user 501 is located outside the AI object 530. The processor 410 may identify that the obtaining of the execution result for the input of the user 501 is completed after the gaze 505 of the user 501 is located outside the AI object 530.

The processor 410 may identify the gaze 505 of the user 501. When the execution result for the input of the user 501 is generated, the processor 410 may identify the gaze 505 of the user 501. When the execution result for the input of the user 501 is generated, the processor 410 may notify the user 501 that the generation of the execution result is completed, based on the gaze 505 of the user 501.

In a case in which the gaze 505 of the user 501 is identified as being located outside the first reference distance from the AI object 530, the processor 410 may change a display position of the AI object 530. For example, the processor 410 may move the display position of the AI object 530 in a direction of the gaze 505 of the user 501. For example, the processor 410 may move the display position of the AI object 530 to a position adjacent to the content 520 toward which the gaze 505 of the user 501 is directed. For example, referring to the situation 605 of FIG. 6C, the processor 410 may move the display position of the AI object 530 to a periphery of the content 520 toward which the gaze 505 of the user 501 is directed. For example, the processor 410 may move the display position of the AI object 530 in the direction of the gaze 505 of the user 501 and may change the display of the AI object 530.

In a case in which the gaze 505 of the user 501 is identified as being located within the first reference distance from the AI object 530, the processor 410 may output the execution result. In a case in which the gaze 505 of the user 501 is identified as being located within the first reference distance from the moved AI object 530, the processor 410 may output the execution result.

As described above, the wearable device 401 may provide improved responsiveness to the user 501 based on the gaze 505 of the user 501 by moving the AI object 530 in the direction of the gaze 505 of the user 501.

FIG. 6D illustrates an example of a screen displayed by a wearable device 401 in an embodiment.

The wearable device 401 of FIG. 6D may correspond to the electronic device 101 of FIG. 1. The wearable device 401 of FIG. 6D may correspond to the wearable device 200 of FIGS. 2A and 2B. The wearable device 401 of FIG. 6D may correspond to the wearable device 300 of FIGS. 3A and 3B. The wearable device 401 of FIG. 6D may correspond to the wearable device 401 of FIG. 4. FIG. 6D may be described with reference to FIGS. 1, 2A, 2B, 3A, 3B, and 4.

Situation 606 of FIG. 6D may exemplify situations following the situations 601 and 602 of FIG. 6A. For example, the situation 606 of FIG. 6D may exemplify situations after the processor 410 obtains the input (e.g., voice input) of the user 501 via the AI assistant 485.

For example, the processor 410 may identify that an execution result for the input of the user 501 is generated. For example, the processor 410 may identify that the execution result for the input of the user 501 is generated via the AI assistant 485. For example, the processor 410 may identify the obtaining of data for outputting the execution result for the input of the user 501 via the AI assistant 485. The processor 410 may identify the obtaining of the execution result for the input of the user 501 after the gaze 505 of the user 501 is located outside the AI object 530. The processor 410 may identify that the obtaining of the execution result for the input of the user 501 is completed after the gaze 505 of the user 501 is located outside the AI object 530.

Referring to the situation 606 of FIG. 6D, the processor 410 may determine whether to output the execution result. The processor 410 may determine whether to output the execution result in response to identifying that the obtaining of the execution result is completed. The processor 410 may determine whether to output the execution result based on whether outputting the execution result is urgent. The processor 410 may determine whether to output the execution result based on whether outputting the execution result should be completed within a designated time.

The processor 410 may suspend outputting the execution result in response to identifying that outputting the execution result does not need to be completed within the designated time. For example, the processor 410 may suspend outputting the execution result until a time point when outputting the execution result is required. Herein, the time point when outputting the execution result is required may vary according to intent of the voice input of the user 501. For example, in a case in which the user 501 has set a time point for requesting the output of the execution result, the processor 410 may suspend outputting the execution result until the time point requested by the user 501.

The processor 410 may output the execution result in a case in which it is identified that outputting the execution result should be completed within the designated time. The processor 410 may output the execution result regardless of the gaze 505 of the user 501 in a case in which it is identified that outputting the execution result should be completed within the designated time. For example, the processor 410 may output the execution result in a case in which the time point when outputting the execution result is required has arrived. For example, the processor 410 may output the execution result even when the gaze 505 of the user 501 is not directed toward the AI object 530 in a case in which it is identified that outputting the execution result should be completed within the designated time. For example, in a case in which the user 501 inquires about the arrival time of a specific bus, and the specific bus is about to arrive, the processor 410 may output an audio signal indicating the execution result (e.g., “The bus you inquired about is arriving soon”) even when the gaze 505 of the user 501 is not directed toward the AI object 530.

As described above, the wearable device 401 may prevent degradation of a user experience of the wearable device 401 by providing the execution result regardless of the gaze 505 of the user 501 in a situation in which the user 501 is focused on content.

FIG. 6E illustrates an example of a screen displayed by a wearable device 401 in an embodiment.

The wearable device 401 of FIG. 6E may correspond to the electronic device 101 of FIG. 1. The wearable device 401 of FIG. 6E may correspond to the wearable device 200 of FIGS. 2A and 2B. The wearable device 401 of FIG. 6E may correspond to the wearable device 300 of FIGS. 3A and 3B. The wearable device 401 of FIG. 6E may correspond to the wearable device 401 of FIG. 4. FIG. 6E may be described with reference to FIGS. 1, 2A, 2B, 3A, 3B, and 4.

A processor 410 may obtain input of a user 501. The processor 120 may obtain input of the user 501 including a trigger. Herein, the trigger may include a keyword for calling an AI assistant 485. For example, the trigger may be Hi Bixby. However, the present disclosure is not limited to the above example elements.

Referring to situation 607 of FIG. 6E, the processor 410 may obtain input “Tell me the bus arrival time” via an input module 150. For example, the processor 410 may obtain input including a trigger and the utterance “Tell me the bus arrival time” via the input module 150.

The processor 410 may activate the AI assistant 485 based on obtaining the input of the user 501. Herein, ‘activating the AI assistant 485’ may mean executing the AI assistant 485. ‘Activating the AI assistant 485’ may mean delivering the input (e.g., voice input) of the user 501 to the AI assistant 485.

The processor 410 may identify an intent of the user 501 via the AI assistant 485 based on the input of the user 501. The processor 410 may establish a plan corresponding to the intent of the user 501 via the AI assistant 485. The processor 410 may execute the plan established via the AI assistant 485. The processor 410 may obtain an execution result of the established plan via the AI assistant 485. Herein, the execution result may include feedback to be provided to the user 501. The feedback may include at least one of voice feedback or visual feedback. Herein, the visual feedback may be based on at least one of an image, a video, or text.

The processor 410 may obtain an execution result based on the input (e.g., voice input) of the user 501 via the AI assistant 485. For example, the processor 410 may identify that the execution result for the input of the user 501 is generated. For example, the processor 410 may identify that the execution result for the input of the user 501 is generated via the AI assistant 485. For example, the processor 410 may identify the obtaining of data for outputting the execution result for the input of the user 501 via the AI assistant 485.

The processor 410 may notify the user 501 that the generation of the execution result is completed. For example, the processor 410 may output a notification associated with the AI assistant 485 indicating that a task is completed based on the generation of the execution result being completed. For example, the processor 410 may output a notification associated with the AI assistant 485 indicating that a task is completed via a display 420 based on the execution result being generated. For example, the processor 410 may output a notification associated with the AI assistant 485 indicating that a task is completed based on the execution result being generated. Referring to situation 608 of FIG. 6E, the processor 410 may output a notification associated with the AI assistant 485 indicating that a task is completed via the sound output module 155 (e.g., the speaker) based on the execution result being generated.

The processor 410 may determine whether to output the execution result. The processor 410 may determine whether to output the execution result in response to identifying that the obtaining of the execution result is completed. The processor 410 may determine whether to output the execution result based on whether outputting the execution result is urgent. The processor 410 may determine whether to output the execution result based on whether outputting the execution result should be completed within a designated time.

The processor 410 may suspend outputting the execution result in response to identifying that outputting the execution result does not need to be completed within the designated time. For example, the processor 410 may suspend outputting the execution result until a time point when outputting the execution result is required. Herein, the time point when outputting the execution result is required may vary according to the intent of the voice input of the user 501. For example, in a case in which the user 501 has set a time point for requesting the output of the execution result, the processor 410 may suspend outputting the execution result until the time point requested by the user 501.

The processor 410 may output the execution result in a case in which it is identified that outputting the execution result should be completed within the designated time. The processor 410 may output the execution result regardless of a gaze 505 of the user 501 in a case in which it is identified that outputting the execution result should be completed within the designated time. For example, the processor 410 may output the execution result in a case in which the time point when outputting the execution result is required has arrived. For example, the processor 410 may output the execution result even when the gaze 505 of the user 501 is not directed toward an AI object 530 in a case in which it is identified that outputting the execution result should be completed within the designated time. For example, in a case in which the user 501 inquires about the arrival time of a specific bus, and the specific bus is about to arrive, the processor 410 may output the execution result (e.g., “The bus you inquired about is arriving soon”) even when the gaze 505 of the user 501 is not directed toward the AI object 530.

FIG. 7 illustrates an example of a screen displayed by a wearable device 401 in an embodiment.

The wearable device 401 of FIG. 7 may correspond to the electronic device 101 of FIG. 1. The wearable device 401 of FIG. 7 may correspond to the wearable device 200 of FIGS. 2A and 2B. The wearable device 401 of FIG. 7 may correspond to the wearable device 300 of FIGS. 3A and 3B. The wearable device 401 of FIG. 7 may correspond to the wearable device 401 of FIG. 4. FIG. 7 may be described with reference to FIGS. 1, 2A, 2B, 3A, 3B, and 4.

The wearable device 401 may include at least one microphone buffer 730 in memory 415.

Referring to situation 701 of FIG. 7, a processor 410 may identify that a gaze 505 of a user 501 has moved. The processor 410 may identify that the gaze 505 of the user 501 has moved based on execution of a gaze tracker 474. The processor 410 may identify that the gaze 505 of the user 501 is directed toward an AI object 530.

The processor 410 may store an utterance of the user 501. The processor 410 may store an utterance of the user 501 obtained via an input module 150. The processor 410 may store an utterance of the user 501 in the microphone buffer 730.

The processor 410 may store the utterance of the user 501 in the microphone buffer 730 while the gaze 505 of the user 501 is moving. For example, the processor 410 may store the utterance of the user 501 in the microphone buffer 730 while the gaze 505 of the user 501 is moving from a content 520 to the AI object 530.

The processor 410 may obtain user input based on at least one utterance of the user 501 stored in the microphone buffer 730, based on the gaze 505 of the user 501 moving to the AI object 530.

In a case in which the gaze 505 of the user 501 is located on the AI object 530, the processor 410 may utilize one or more utterances among the utterances of the user 501 stored in the microphone buffer 730 as the user input. For example, the processor 410 may utilize a first utterance stored in the microphone buffer 730 while the gaze 505 of the user 501 moved to the AI object 530, a second utterance stored in the microphone buffer 730 while the gaze 505 of the user 501 was located on the AI object 530, and a third utterance stored in the microphone buffer 730 while the gaze 505 of the user 501 moved away from the AI object 530, among the first utterance, the second utterance, the third utterance, or a fourth utterance, as the user input. However, the present disclosure is not limited to the above example elements. For example, the processor 410 may select different numbers of the utterances according to a word included in the first utterance, the second utterance, the third utterance, or the fourth utterance, and/or an intent of the user 501. For example, the processor 410 may utilize the first utterance and the second utterance as the user input. For example, the processor 410 may utilize the second utterance and the third utterance as the user input. For example, the processor 410 may utilize the second utterance, the third utterance, and the fourth utterance as the user input.

As described above, the wearable device 401 may reduce latency for voice input of the user 501 by using the utterance after an AI assistant 485 is triggered by the gaze 505 and the prior utterance, as voice input.

FIG. 8 illustrates an example of a screen displayed by a wearable device 401 in an embodiment.

The wearable device 401 of FIG. 8 may correspond to the electronic device 101 of FIG. 1. The wearable device 401 of FIG. 8 may correspond to the wearable device 200 of FIGS. 2A and 2B. The wearable device 401 of FIG. 8 may correspond to the wearable device 300 of FIGS. 3A and 3B. The wearable device 401 of FIG. 8 may correspond to the wearable device 401 of FIG. 4. FIG. 8 may be described with reference to FIGS. 1, 2A, 2B, 3A, 3B, and 4.

A processor 410 may provide a virtual space service based on execution of a virtual space manager 451. For example, the processor 410 may display a screen 820 indicating real space obtained via a camera 425 on at least a portion of a display 420 based on execution of a pass-through manager 453. For example, the processor 410 may display the screen 820 indicating the real space obtained via the camera 425 on an entire area of a FOV 510, based on execution of the pass-through manager 453. Hereinafter, the screen 820 indicating the real space may be referred to as a pass-through screen 820.

The processor 410 may identify a gaze 505 of a user 501. For example, the processor 410 may identify the gaze 505 of the user 501 on the pass-through screen 820.

The processor 410 may identify that the gaze 505 of the user 501 is located on an object 810. For example, the processor 410 may identify that the gaze 505 of the user 501 is located on the object 810 for a designated time or longer. Herein, the object 810 may be an object included in the pass-through screen 820. The object 810 on which the gaze 505 of the user 501 is located for the designated time or longer may be referred to as an object of interest.

The processor 410 may display an AI object 530 on the display 420 based on the gaze 505 of the user 501. For example, the processor 410 may display the AI object 530 on the display 420 based on the gaze 505 of the user 501 being located on the object 810 for the designated time or longer. For example, the processor 410 may display the AI object 530 on the pass-through screen 820 based on the gaze 505 of the user 501 being located on the object 810 for the designated time or longer. For example, the processor 410 may display the AI object 530 around the object 810 of the pass-through screen 820. For example, referring to situation 801 of FIG. 8, the processor 410 may overlappingly display the AI object 530 on the pass-through screen 820.

The processor 410 may obtain input of the user 501 while the AI object 530 is displayed around the object 810.

The processor 410 may identify an intent of the user 501 via an AI assistant 485 based on the input of the user 501. For example, the processor 410 may identify the intent of the user 501 via the AI assistant 485 based on the object 810 on which the gaze 505 is located for the designated time or longer and the input of the user 501. For example, the processor 410 may identify the intent of the user 501 via the AI assistant 485 based on information regarding the object 810 and the input of the user 501. For example, in a case in which the object 810 is “coffee shop” and the input of the user 501 is “What menu do they have?”, the processor 410 may obtain information regarding a menu sold at the “coffee shop” associated with the object 810 via the AI assistant 485. The processor 410 may provide the obtained information associated with the object 810 to the user 501.

Referring to the situation 801 of FIG. 8, the processor 410 may identify that the gaze 505 of the user 501 has moved. The processor 410 may identify that the gaze 505 of the user 501 has moved from the object 810. The processor 410 may identify that the gaze 505 of the user 501 505 is located outside the object 810.

The processor 410 may change display of the AI object 530 based on the gaze 505 of the user 501. For example, the processor 410 may change a display position of the AI object 530 based on the gaze 505 of the user 501 being located outside the object 810. For example, the processor 410 may display the AI object 530 outside the pass-through screen 820 based on the gaze 505 of the user 501 being located outside the object 810. For example, the processor 410 may move the AI object 530 outside the pass-through screen 820 based on the gaze 505 of the user 501 being located outside the object 810.

While outputting the information associated with the object 810, the processor 410 may determine whether to cease outputting the information. The processor 410 may determine whether to cease outputting the information based on the gaze 505 of the user 501. The processor 410 may cease outputting the information based on the gaze 505 of the user 501 being located outside the object 810.

After the output of the information has been ceased, the processor 410 may resume outputting the information based on identifying that the gaze of the user 501 is located within a first reference distance from the object 810. Herein, ‘resuming outputting the information’ may mean outputting the information again from a portion where outputting the information was ceased. ‘Resuming outputting the information’ may mean newly initiating outputting the information.

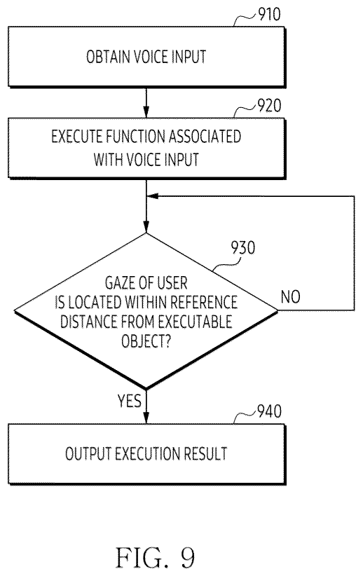

FIG. 9 illustrates a flowchart of operations performed by a wearable device 401 in an embodiment. FIG. 9 may be described with reference to FIGS. 1, 2A, 2B, 3A, 3B, 4, and 5A.

Referring to FIG. 9, in operation 910, a processor 410 may obtain voice input. The processor 410 may obtain voice input of a user 501 via an input module 150. However, the present disclosure is not limited to the above example elements. The processor 410 may obtain at least one of text input or voice input via the input module 150.

In operation 920, the processor 410 may execute a function associated with the voice input. The processor 410 may execute the function associated with the voice input via an AI assistant 485 of the user 501. The processor 410 may obtain an execution result of the function associated with the voice input via the AI assistant 485 of the user 501. For example, the processor 410 may identify an intent of the user 501 via the AI assistant 485 based on the voice input of the user 501. The processor 410 may establish a plan corresponding to the intent of the user 501 via the AI assistant 485. The processor 410 may execute the plan established via the AI assistant 485. The processor 410 may obtain an execution result of the established plan via the AI assistant 485.

In operation 930, the processor 410 may determine whether a gaze 505 of the user 501 is located within a reference distance from an executable object 530. While obtaining the execution result of the function associated with the voice input of the user 501 via the AI assistant 485, the processor 410 may determine whether the gaze 505 of the user 501 is located within a first reference distance from the executable object 530. Herein, the first reference distance may be or correspond to a distance at which the user 501 is recognized as interacting with the AI object 530. The first reference distance may be set according to a size of the AI object 530.

In operation 930, in a case in which the gaze 505 of the user 501 is located within the reference distance from the executable object 530 (‘YES’), the processor 410 may perform operation 940. In the operation 930, in a case in which the gaze 505 of the user 501 is located outside the reference distance from the executable object 530 (‘NO’), the processor 410 may perform the operation 930 again.

In operation 940, the processor 410 may output the execution result. The processor 410 may output the execution result based on data for outputting the execution result. The processor 410 may output the execution result via a sound output module 155. The processor 410 may output the execution result via a display 420. The processor 410 may output the execution result via the sound output module 155 and the display 420. For example, the processor 410 may output a screen indicating the execution result via the display 420.

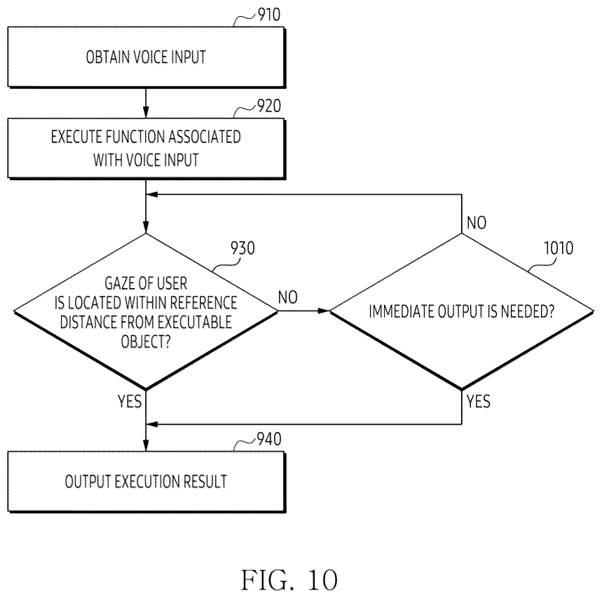

FIG. 10 illustrates a flowchart of operations performed by a wearable device 401 in an embodiment.

FIG. 10 may be described with reference to FIGS. 1, 2A, 2B, 3A, 3B, 4, and 5A. Operations 910, 920, 930, and 940 of FIG. 10 may respectively correspond to the operations 910, 920, 930, and 940 of FIG. 9.

Referring to FIG. 10, in operation 910, a processor 410 may obtain voice input. The processor 410 may obtain voice input of a user 501 via an input module 150. However, the present disclosure is not limited to the above example elements. The processor 410 may obtain at least one of text input or voice input via the input module 150.

In operation 920, the processor 410 may execute a function associated with the voice input. The processor 410 may execute the function associated with the voice input via an AI assistant 485 of the user 501. The processor 410 may obtain an execution result of the function associated with the voice input via the AI assistant 485 of the user 501. For example, the processor 410 may identify an intent of the user 501 via the AI assistant 485 based on the voice input of the user 501. The processor 410 may establish a plan corresponding to the intent of the user 501 via the AI assistant 485. The processor 410 may execute the plan established via the AI assistant 485. The processor 410 may obtain an execution result of the established plan via the AI assistant 485.

In operation 930, the processor 410 may determine whether a gaze of the user is located within a reference distance from an executable object. While obtaining the execution result of the function associated with the voice input of the user 501 via the AI assistant 485, the processor 410 may determine whether a gaze 505 of the user 501 is located within a second reference distance from an executable object 530. Herein, the second reference distance may be or correspond to a distance at which the user 501 is recognized as disengaging from interaction with an AI object 530. The second reference distance may be longer than the first reference distance. However, the present disclosure is not limited to the above example elements. For example, the second reference distance may be equal to the first reference distance.

In operation 930, in a case in which the gaze 505 of the user 501 is located within the reference distance from the executable object 530 (‘YES’), the processor 410 may perform operation 940. In the operation 930, in a case in which the gaze 505 of the user 501 is located outside the reference distance from the executable object 530 (‘NO’), the processor 410 may perform operation 1010.

In operation 1010, the processor 410 may determine whether immediate output is needed. The processor 410 may determine whether to output the execution result immediately based on whether outputting the execution result is needed (or urgent). The processor 410 may determine whether to output the execution result based on whether outputting the execution result should be completed within a designated time. For example, the processor 410 may determine whether a time point when outputting the execution result is required has arrived. Herein, the time point when outputting the execution result is required may vary according to the intent of the voice input of the user 501. For example, in a case in which the user 501 has set a time point for requesting the output of the execution result, the processor 410 may suspend outputting the execution result until the time point requested by the user 501.

In the operation 1010, in a case in which the immediate output of the execution result is needed (‘YES’), the processor 410 may perform the operation 940. In the operation 1010, in a case in which the immediate output is not needed (‘NO’), the processor 410 may perform the operation 930 again.

In operation 940, the processor 410 may output the execution result. The processor 410 may output the execution result based on data for outputting the execution result. The processor 410 may output the execution result via a sound output module 155. The processor 410 may output the execution result via a display 420. The processor 410 may output the execution result via the sound output module 155 and the display 420. For example, the processor 410 may output a screen indicating the execution result via the display 420.

FIG. 11 illustrates a flowchart of operations performed by a wearable device in an embodiment.

FIG. 11 may be described with reference to FIGS. 1, 2A, 2B, 3A, 3B, 4, and 5A.

Referring to FIG. 11, in operation 1110, a processor 410 may initiate outputting an execution result. The processor 410 may output the execution result based on data for outputting the execution result. The processor 410 may output the execution result via a sound output module 155. The processor 410 may output the execution result via a display 420. The processor 410 may output the execution result via the sound output module 155 and the display 420. For example, the processor 410 may output a screen indicating the execution result via the display 420.

In a case in which a gaze 505 of a user 501 is identified as being located within a first reference distance from an AI object 530, the processor 410 may output the execution result. The processor 410 may output the execution result based on the data for outputting the execution result in response to identifying that the gaze 505 of the user 501 is located within the first reference distance from the AI object 530.

In operation 1120, the processor 410 may determine whether the gaze 505 of the user 501 is located within a reference distance from an executable object. The processor 410 may determine whether the gaze 505 of the user 501 is located within a second reference distance from the AI object 530. The processor 410 may determine whether the gaze 505 of the user 501 is located within the second reference distance from the AI object 530 in order to determine whether to cease outputting the execution result. Herein, the second reference distance may be or correspond to a distance at which the user 501 is recognized as disengaging from interaction with the AI object 530. The second reference distance may be longer than the first reference distance. However, the present disclosure is not limited to the above example elements. For example, the second reference distance may be equal to the first reference distance.

In the operation 1120, in a case in which the gaze 505 of the user 501 is located within the reference distance from the executable object (‘YES’), the processor 410 may perform operation 1130. In the operation 1120, in a case in which the gaze 505 of the user 501 is located outside the reference distance from the executable object (‘NO’), the processor 410 may perform operation 1140.

In operation 1130, the processor 410 may continue outputting the execution result. The processor 410 may continue outputting the execution result based on the gaze of the user 501 being located within the second reference distance from the AI object 530.

In operation 1140, the processor 410 may cease outputting the execution result. The processor 410 may cease outputting the execution result based on the gaze of the user 501 being located outside the reference distance from the AI object 530. The processor 410 may cease outputting the execution result based on identifying that the gaze of the user 501 is located outside the reference distance from the AI object 530.

According to an embodiment, the processor 410 may continue outputting the execution result in another manner. For example, the processor 410 may continue outputting the execution result in another manner based on the gaze 505 of the user 501 being located outside the reference distance from the executable object. For example, a processor 410 may output the execution result, which is output as audio, based on text, based on the gaze 505 of the user 501 being located outside the reference distance from the executable object.

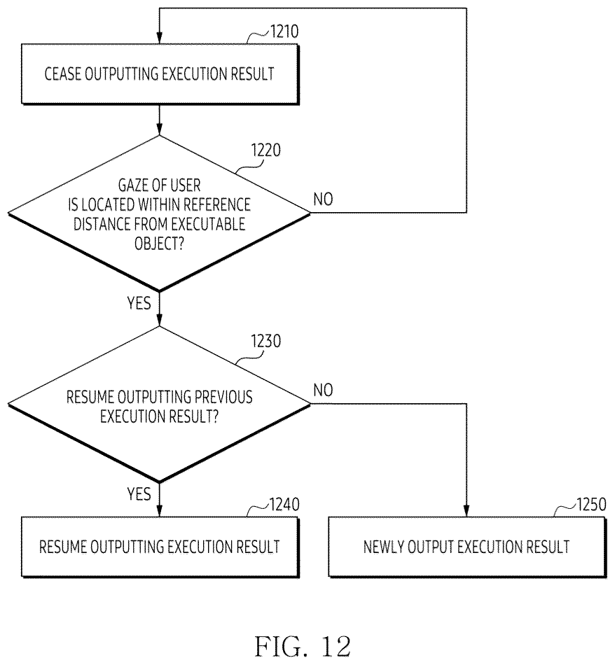

FIG. 12 illustrates a flowchart of operations performed by a wearable device 401 in an embodiment.

FIG. 12 may be described with reference to FIGS. 1, 2A, 2B, 3A, 3B, 4, and 5A.

Referring to FIG. 12, in operation 1210, a processor 410 may cease outputting an execution result. The processor 410 may cease outputting the execution result based on a gaze of a user 501 being located outside a reference distance from an AI object 530. The processor 410 may cease outputting the execution result based on identifying that the gaze of the user 501 is located outside the reference distance from the AI object 530.

In operation 1220, the processor 410 may determine whether the gaze of the user is located within the reference distance from an executable object. The processor 410 may determine whether the gaze of the user 501 is located within a first reference distance from the AI object 530 in order to determine whether to resume outputting the execution result. Herein, the first reference distance may be or correspond to a distance at which the user 501 is recognized as interacting with the AI object 530. The first reference distance may be set according to a size of the AI object 530.

In operation 1220, in a case in which a gaze 505 of the user 501 is located within the reference distance from the executable object (‘YES’), the processor 410 may perform operation 1230. In the operation 1220, in a case in which the gaze 505 of the user 501 is located outside the reference distance from the executable object (‘NO’), the processor 410 may perform the operation 1210 again.

In operation 1230, the processor 410 may determine whether to resume outputting the previous execution result. The processor 410 may determine whether to resume outputting the previous execution result based on an elapsed time from a time point when outputting the execution result was ceased. The processor 410 may determine whether the elapsed time from the time point when outputting the execution result was ceased is within a reference time. The processor 410 may determine to resume outputting the previous execution result in a case in which the elapsed time from the time point when outputting the execution result was ceased is within the reference time. The processor 410 may determine to newly output the previous execution result in a case in which the elapsed time from the time point when outputting the execution result was ceased exceeds the reference time.

In the operation 1230, in a case in which it is determined to resume outputting the previous execution result (‘YES’), the processor 410 may perform operation 1240. In the operation 1230, in a case in which it is determined not to resume outputting the previous execution result (‘NO’), the processor 410 may perform operation 1250.

In operation 1240, the processor 410 may resume outputting the execution result. Herein, ‘resuming outputting the execution result’ may mean outputting the execution result again from a portion where outputting the execution result was ceased. The processor 410 may output the execution result based on the point where outputting the execution result was ceased.

The processor 410 may generate data summarizing the previously output portion and may output the generated data in response to the elapsed time from the time point when outputting the execution result was ceased exceeding the reference time. After outputting the generated data, the processor 410 may output again from the portion where outputting the execution result was ceased. Herein, a length of time required to output the data summarizing the previously output portion may increase based on the elapsed time from the time point of cessation. The processor 410 may output again from a predetermined time before the ceased portion in response to the elapsed time from the time point when outputting the execution result was ceased being within the reference time. Herein, the predetermined time may increase based on the elapsed time from the time point of cessation.

In operation 1250, the processor 410 may newly output the execution result. Herein, ‘newly outputting the execution result’ may mean outputting the execution result from the beginning.

As described above, a wearable device 401 may include at least one sensor 430 obtaining data for identifying a gaze 505 of a user 501 wearing the wearable device 401. The wearable device 401 may include a display 420 capable of displaying a stereoscopic image. The wearable device 401 may include at least one microphone. The wearable device 401 may include at least one processor 410. The wearable device 401 may include memory 415 storing instructions. The instructions, when executed by the at least one processor 410, may cause the wearable device 401 to obtain voice input of the user 501 via the at least one microphone. The instructions, when executed by the at least one processor 410, may cause the wearable device 401 to execute a function indicated by the voice input of the user, based on an artificial intelligence (AI) assistant. The instructions, when executed by the at least one processor 410, may cause the wearable device 401 to identify the gaze 505 of the user 501 based on the data obtained via the at least one sensor 430. The instructions, when executed by the at least one processor 410, may cause the wearable device 401, in response to data for outputting an execution result of the function indicated by the voice input being generated, to identify whether the gaze 505 is located within a first reference distance from a visual object 530 associated with the AI assistant 485 displayed on the display 420. The instructions, when executed by the at least one processor 410, may cause the wearable device 401, in response to identifying that the gaze 505 is located within the first reference distance from the visual object 530, based on the data for outputting the execution result, to output the execution result. The instructions, when executed by the at least one processor 410, may cause the wearable device 401, in response to identifying that the gaze 505 is located outside the first reference distance from the visual object 530, to postpone outputting the execution result.

The instructions, when executed by the at least one processor 410, may cause the wearable device 401 to identify whether the gaze 505 is located within a second reference distance from the visual object 530 while outputting the execution result. The instructions, when executed by the at least one processor 410, may cause the wearable device 401, based on identifying that the gaze 505 is located outside the second reference distance from the visual object 530, to cease outputting the execution result.

The instructions, when executed by the at least one processor 410, may cause the wearable device 401, in response to identifying that the gaze 505 is located outside the second reference distance from the visual object 530, to identify a time required to complete outputting the execution result. The instructions, when executed by the at least one processor 410, may cause the wearable device 401, in response to the identified required time being equal to or less than a first reference time, to continue outputting the execution result. The instructions, when executed by the at least one processor 410, may cause the wearable device 401, in response to the identified required time exceeding the first reference time, to cease outputting the execution result.

The instructions, when executed by the at least one processor 410, may cause the wearable device 401 to resume outputting the execution result based on identifying that the gaze 505 is located within the first reference distance from the visual object 530, after ceasing outputting the execution result.

The instructions, when executed by the at least one processor 410, may cause the wearable device 401, in response to a time elapsed from a time point when outputting the execution result was ceased exceeding a second reference time, to output the execution result from the beginning. The instructions, when executed by the at least one processor 410, may cause the wearable device 401, in response to the time elapsed from the time point when outputting the execution result was ceased being within the second reference time, to resume outputting the execution result based on a portion where outputting the execution result was ceased.

The instructions, when executed by the at least one processor 410, may cause the wearable device 401 to identify whether the gaze 505 is located within a third reference distance from the visual object 530. The instructions, when executed by the at least one processor 410, may cause the wearable device 401, in response to identifying that the gaze 505 is located within the third reference distance from the visual object 530, to identify the voice input from an utterance of the user 501 obtained via the at least one microphone.

The instructions, when executed by the at least one processor 410, may cause the wearable device 401, in response to the data for outputting the execution result being generated, to change the display of the visual object 530.

As described above, the wearable device 401 may further include at least one speaker. The instructions, when executed by the at least one processor 410, may cause the wearable device 401, in response to identifying that the gaze 505 is located within the first reference distance from the visual object 530, to output the execution result via the display 420 and/or the at least one speaker. The instructions, when executed by the at least one processor 410, may cause the wearable device 401, while outputting the execution result, based on identifying that the gaze 505 is located outside a second reference distance from the visual object 530, to display the execution result as text on the display 420.

The text may be displayed within a designated distance from the visual object 530.

The instructions, when executed by the at least one processor 410, may cause the wearable device 401, in response to the gaze 505 of the user 501 being maintained on a designated object for a third reference time, to display the visual object 530 within a fourth reference distance from the designated object.

As described above, the wearable device 401 may further include at least one camera 425 configured to photograph an external environment of the wearable device 401. The instructions, when executed by the at least one processor 410, may cause the wearable device 401 to identify a designated object from an image obtained via the at least one camera 425. The instructions, when executed by the at least one processor 410, may cause the wearable device 401, in response to identifying the designated object from the image, to display the visual object 530 within a fourth reference distance from the designated object on the display 420.

The instructions, when executed by the at least one processor 410, may cause the wearable device 401 to execute the function based on information regarding the designated object and the voice input.

The instructions, when executed by the at least one processor 410, may cause the wearable device 401 to identify whether the execution result needs to be output within a fourth reference time. The instructions, when executed by the at least one processor 410, may cause the wearable device 401, in response to identifying that the execution result needs to be output within the fourth reference time, to output the execution result regardless of the gaze 505.

The instructions, when executed by the at least one processor 410, may cause the wearable device 401, in response to identifying that the gaze 505 is located within the first reference distance from the visual object 530, to change the display of the visual object 530. The instructions, when executed by the at least one processor 410, may cause the wearable device 401, in response to changing the display of the visual object 530, to obtain the voice input via the at least one microphone.

As described above, a method may be executed by a wearable device 401 including at least one sensor 430 obtaining data for identifying a gaze 505 of a user 501 wearing the wearable device 401, a display 420 capable of displaying a stereoscopic image, and at least one microphone. The method may include obtaining voice input of the user 501 via the at least one microphone. The method may include executing a function indicated by the voice input of the user, based on an artificial intelligence (AI) assistant. The method may include identifying the gaze 505 of the user 501, based on the data obtained via the at least one sensor 430. The method may include, in response to data for outputting an execution result of the function indicated by the voice input being generated, identifying whether the gaze 505 is located within a first reference distance from a visual object 530 associated with the AI assistant 485 displayed on the display 420. The method may include, in response to identifying that the gaze 505 is located within the first reference distance from the visual object 530, based on the data for outputting the execution result, outputting the execution result. The method may include, in response to identifying that the gaze 505 is located outside the first reference distance from the visual object 530, postponing outputting the execution result.

The method may include identifying whether the gaze 505 is located within a second reference distance from the visual object 530 while outputting the execution result. The method may include, based on identifying that the gaze 505 is located outside the second reference distance from the visual object 530, ceasing outputting the execution result.

The method may include, in response to identifying that the gaze 505 is located outside the second reference distance from the visual object 530, identifying a time required to complete outputting the execution result. The method may include, in response to the identified required time being equal to or less than a first reference time, continuing outputting the execution result. The method may include, in response to the identified required time exceeding the first reference time, ceasing outputting the execution result.

The method may include resuming outputting the execution result based on identifying that the gaze 505 is located within the first reference distance from the visual object 530, after ceasing outputting the execution result.

The method may include, in response to a time elapsed from a time point when outputting the execution result was ceased exceeding a second reference time, outputting the execution result from the beginning. The method may include, in response to the time elapsed from the time point when outputting the execution result was ceased being within the second reference time, resuming outputting the execution result based on a portion where outputting the execution result was ceased.

The method may include identifying whether the gaze 505 is located within a third reference distance from the visual object 530. The method may include, in response to identifying that the gaze 505 is located within the third reference distance from the visual object 530, identifying the voice input from an utterance of the user 501 obtained via the at least one microphone.

As described above, a non-transitory computer readable storage medium may include a program including instructions. The instructions, when executed by at least one processor 410 of a wearable device 401 comprising at least one sensor 430 obtaining data for identifying a gaze 505 of a user 501 wearing the wearable device 401, a display 420 capable of displaying a stereoscopic image, and at least one microphone, may cause the wearable device 401 to obtain voice input of the user 501 via the at least one microphone. The instructions, when executed by the at least one processor 410, may cause the wearable device 401 to execute a function indicated by the voice input of the user, based on an artificial intelligence (AI) assistant. The instructions, when executed by the at least one processor 410, may cause the wearable device 401 to identify the gaze 505 of the user 501 based on the data obtained via the at least one sensor 430. The instructions, when executed by the at least one processor 410, may cause the wearable device 401, in response to data for outputting an execution result of the function indicated by the voice input being generated, to identify whether the gaze 505 is located within a first reference distance from a visual object 530 associated with the AI assistant 485 displayed on the display 420. The instructions, when executed by the at least one processor 410, may cause the wearable device 401, in response to identifying that the gaze 505 is located within the first reference distance from the visual object 530, based on the data for outputting the execution result, to output the execution result. The instructions, when executed by the at least one processor 410, may cause the wearable device 401, in response to identifying that the gaze 505 is located outside the first reference distance from the visual object 530, to postpone outputting the execution result.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., through a wire or wires), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. A wearable device comprising:
at least one sensor configured to data for identifying a gaze of a user wearing the wearable device;
a display configured to display a stereoscopic image;
at least one microphone;
at least one processor; and
memory storing instructions, wherein the instructions are configured, when executed by the at least one processor, to cause the wearable device to:
obtain a voice input of the user via the at least one microphone,
execute a function indicated by the voice input of the user, based on an artificial intelligence (AI) voice recognition model,
identify the gaze of the user, based on the data obtained via the at least one sensor,
based on data for outputting an execution result of the function indicated by the voice input being generated, identify whether the gaze is located within a first reference distance from a visual object associated with the AI voice recognition model displayed on the display,
based on identifying that the gaze is located within the first reference distance from the visual object and based on the data for outputting the execution result, output the execution result, and
based on identifying that the gaze is located outside the first reference distance from the visual object, postpone outputting the execution result.

2. The wearable device of claim 1, wherein the instructions are configured, when executed by the at least one processor, to further cause the wearable device to:
while outputting the execution result, identify whether the gaze is located within a second reference distance from the visual object, and
based on identifying that the gaze is located outside the second reference distance from the visual object, cease outputting the execution result.

3. The wearable device of claim 2, wherein the instructions are configured, when executed by the at least one processor, to further cause the wearable device to:
based on identifying that the gaze is located outside the second reference distance from the visual object, identify a time required to complete outputting the execution result,
based on the identified required time being equal to or less than a first reference time, continue outputting the execution result, and
based on the identified required time being longer than the first reference time, cease outputting the execution result.

4. The wearable device of claim 2, wherein the instructions are configured, when executed by the at least one processor, to further cause the wearable device to resume outputting the execution result based on identifying that the gaze is located within the first reference distance from the visual object, after ceasing outputting the execution result.

5. The wearable device of claim 4, wherein the instructions are configured, when executed by the at least one processor, to further cause the wearable device to:
based on a time elapsed from a time point when outputting the execution result was ceased being longer than a second reference time, output the execution result from the beginning, and
based on the time elapsed from the time point when outputting the execution result was ceased being within the second reference time, resume outputting the execution result based on a portion where outputting the execution result was ceased.

6. The wearable device of claim 1, wherein the instructions are configured, when executed by the at least one processor, to further cause the wearable device to:
identify whether the gaze is located within a third reference distance from the visual object, and
based on identifying that the gaze is located within the third reference distance from the visual object, identify the voice input from an utterance of the user obtained via the at least one microphone.

7. The wearable device of claim 1, wherein the instructions are configured, when executed by the at least one processor, to further cause the wearable device to, based on the data for outputting the execution result being generated, change the display of the visual object.

8. The wearable device of claim 1, further comprising at least one speaker,
wherein the instructions are configured, when executed by the at least one processor, to further cause the wearable device to:
based on identifying that the gaze is located within the first reference distance from the visual object, output the execution result via the display or the at least one speaker, and
while outputting the execution result, based on identifying that the gaze is located outside a second reference distance from the visual object, display the execution result as a text on the display.

9. The wearable device of claim 8, wherein the text is displayed within a designated distance from the visual object.

10. The wearable device of claim 1, wherein the instructions are configured, when executed by the at least one processor, to further cause the wearable device to, in response to the gaze of the user being maintained on a designated object for a third reference time, display the visual object within a fourth reference distance from the designated object.

11. The wearable device of claim 1, further comprising at least one camera configured to photograph an external environment of the wearable device,
wherein the instructions are configured, when executed by the at least one processor, to further cause the wearable device to:
identify a designated object from an image obtained via the at least one camera, and based on identifying the designated object from the image, display the visual object within a fourth reference distance from the designated object on the display.

12. The wearable device of claim 11, wherein the instructions are configured, when executed by the at least one processor, to further cause the wearable device to execute the function based on information regarding the designated object and the voice input.

13. The wearable device of claim 1, wherein the instructions are configured, when executed by the at least one processor, to further cause the wearable device to:
identify whether the execution result needs to be output within a fourth reference time, and
based on identifying that the execution result needs to be output within the fourth reference time, output the execution result regardless of the gaze.

14. The wearable device of claim 1, wherein the instructions are configured, when executed by the at least one processor, to further cause the wearable device to:
based on identifying that the gaze is located within the first reference distance from the visual object, change the display of the visual object, and
based on changing the display of the visual object, obtain the voice input via the at least one microphone.

15. A method executed by a wearable device including at least one sensor configured to obtain data for identifying a gaze of a user wearing the wearable device, a display configured to display a stereoscopic image, and at least one microphone, the method comprising:
obtaining a voice input of the user, via the at least one microphone,
executing a function indicated by the voice input of the user, based on an artificial intelligence (AI) voice recognition model,
identifying the gaze of the user, based on the data obtained via the at least one sensor,
based on data for outputting an execution result of the function indicated by the voice input being generated, identifying whether the gaze is located within a first reference distance from a visual object associated with the AI voice recognition model displayed on the display,
based on identifying that the gaze is located within the first reference distance from the visual object and based on the data for outputting the execution result, outputting the execution result, and
based on identifying that the gaze is located outside the first reference distance from the visual object, postponing outputting the execution result.

16. The method of claim 15, further comprising:
while outputting the execution result, identifying whether the gaze is located within a second reference distance from the visual object, and
based on identifying that the gaze is located outside the second reference distance from the visual object, ceasing outputting the execution result.

17. The method of claim 16, further comprising:
based on identifying that the gaze is located outside the second reference distance from the visual object, identifying a time required to complete outputting the execution result,
based on the identified required time being equal to or less than a first reference time, continuing outputting the execution result, and
based on the identified required time being longer than the first reference time, ceasing outputting the execution result.

18. The method of claim 15, further comprising resuming outputting the execution result, based on identifying that the gaze is located within the first reference distance from the visual object, after ceasing outputting the execution result.

19. The method of claim 15, further comprising:
based on a time elapsed from a time point when outputting the execution result was ceased being longer than a second reference time, outputting the execution result from the beginning, and
based on the time elapsed from the time point when outputting the execution result was ceased being within the second reference time, resuming outputting the execution result based on a portion where outputting the execution result was ceased.

20. The method of claim 15, further comprising:
identifying whether the gaze is located within a third reference distance from the visual object, and
based on identifying that the gaze is located within the third reference distance from the visual object, identifying the voice input from an utterance of the user obtained via the at least one microphone.
